(19) United States
(12) Patent Application Publication
(10) Pub. No.: US 2014/0252218 A1
(43) Pub. Date: Sep. 11, 2014

(54) Methods and Apparatus for Decomposing Tandem Mass Spectra Generated by All-Ions Fragmentation

(71) Applicants: David A. WRIGHT, Livermore, CA (US); Thomas D. McCLURE, Sunnyvale, CA (US); Michael J. ATHANAS, San Jose, CA (US)

(72) Inventors: David A. WRIGHT, Livermore, CA (US); Thomas D. McCLURE, Sunnyvale, CA (US); Michael J. ATHANAS, San Jose, CA (US)

(21) Appl. No.: 13/785,620

(22) Filed: Mar. 5, 2013

(51) Int. Cl. H01J 49/00

(52) U.S. Cl. CPC H01J 49/0036
USPC 250/282

(57) ABSTRACT

A method for tandem mass spectrometry of a plurality of eluting compounds comprises: (a) performing, during a time period, the steps of: ionizing the plurality of eluting compounds to generate a plurality of precursor ion species; introducing the plurality of precursor ions into a fragmentation cell operated at constant fragmentation energy so as to generate a plurality of product-ion species from at least a portion of the precursor ion species; and generating a mass spectrum of the plurality of product-ion species; and (b) recognizing matches between certain of the product ion species generated during the time period based on correlations between elution profiles of the product ion species.

### FIELD OF THE INVENTION

This invention relates to methods of analyzing data obtained from instrumental analysis techniques used in analytical chemistry and, in particular, to methods of automatically identifying correlations between product ions and, optionally, between product ions and precursor ions in all-ions tandem mass spectral data generated in LC/MS/MS analyses that do not include a precursor ion selection step.

### BACKGROUND OF THE INVENTION

Mass spectrometry (MS) is an analytical technique to filter, detect, identify and/or measure compounds by the mass-to-charge ratios of ions formed from the compounds. The quantity of mass-to-charge ratio is commonly denoted by the symbol “m/z” in which “m” is ionic mass in units of Daltons and “z” is ionic charge in units of elementary charge, e. Thus, mass-to-charge ratios are appropriately measured in units of “Da/e” Mass spectrometry techniques generally include (1) ionization of compounds and optional fragmentation of the resulting ions so as to form fragment, ions; and (2) detection and analysis of the mass-to-charge ratios of the ions and/or fragment ions and calculation of corresponding ionic masses. The compound may be ionized and detected by any suitable means. A “mass spectrometer” generally includes an ionizer and an ion detector.

The hybrid technique of liquid chromatography-mass spectrometry (LC/MS) is an extremely useful technique for detection, identification and (or) quantification of components of mixtures or of analytes within mixtures. This technique generally provides data in the form of a mass chromatogram, in which detected ion intensity (a measure of the number of detected ions) as measured by a mass spectrometer is given as a function of time. In the LC/MS technique, various separated chemical constituents elute from a chromatographic column as a function of time. As these constituents come off the column, they are submitted for mass analysis by a mass spectrometer. The mass spectrometer accordingly generates, in real time, detected relative ion abundance data for ions produced from each eluting analyte, in turn. Thus, such data is inherently three-dimensional, comprising the two independent variables of time and mass (more specifically, a mass-related variable, such as mass-to-charge ratio) and a measured dependent variable relating to ion abundance. The term “liquid chromatography” includes, without limitation, reverse phase liquid chromatography (RPLC), hydrophilic interaction liquid chromatography (HILIC), high performance liquid chromatography (HPLC), ultra high performance liquid chromatography (UHPLC), normal-phase high performance liquid chromatography (NP-HPLC), supercritical fluid chromatography (SFC) and ion chromatography.

Conventionally, one can often enhance the resolution of the MS technique by employing “tandem mass spectrometry” or “MS/MS”, for example via use of a triple quadrupole mass spectrometer. In this technique, a first (or parent or precursor) ion species generated from a molecular species of interest can be filtered or isolated in an MS instrument. The precursor ions of the various precursor ion species can be subsequently fragmented to yield one or more second (or product or fragment) ions comprising various product/fragment ion species that are then analyzed in a second MS stage. By careful selection of precursor ion species, only ions produced by certain analytes are passed to the fragmentation chamber or other reaction cell, such as a collision cell where collision of ions with atoms of an inert gas produces the product ions. Because both the precursor and product ions are produced in a reproducible fashion under a given set of ionization/fragmentation conditions, the MS/MS technique can provide an extremely powerful analytical tool. For example, the combination of precursor ion selection and subsequent fragmentation and analysis can be used to eliminate interfering substances, and can be particularly useful in complex samples, such as biological samples. Selective reaction monitoring (SRM) is one commonly employed tandem mass spectrometry technique.

There is currently a trend towards full-scan MS experiments in residue analysis. Such full-scan approaches utilize high performance time-of-flight (TOF) or electrostatic trap (such as Orbitrap™-type) mass spectrometers coupled to UHPLC columns and can facilitate rapid and sensitive screening and detection of analytes. The superior resolving power of the Orbitrap™ mass spectrometer (up to 100,000 FWHM) compared to TOF instruments (10,000-20,000) ensures the high mass accuracy required for complex sample analysis.

One example of a mass spectrometer system 15 comprising an electrostatic trap mass analyzer such as an Orbitrap mass analyzer 25 is shown in FIG. 1A. Analyte material 29 is provided to a pulsed or continuous ion source 16 so as to generate ions. Ion source 16 could be a MALDI source, an electrospray source or any other type of ion source. In addition, multiple ion sources may be used. The illustrated system comprises a curved quadrupole trap 18 (also known as a “C-trap”) with a slot 31 in the inner electrode 19. Ions are transferred from the ion source 16 to the curved quadrupole trap 18 by ion optics assembly 17 (e.g. an RF multipole). Prior to ion injection, ions may be squeezed along the axis of the curved quadrupole trap 18 by raising voltages on end electrodes 20 and 21. For ion injection into the Orbitrap mass analyzer 25, the RF voltage on the curved quadrupole trap 18 may be switched off as is well known. Pulses are applied to electrodes 19 and 22 and to an electrode of curved ion optics 28 so that the transverse electric field accelerates ions into the curved ion optics 28. The converging ion beam that results enters the Orbitrap mass analyzer 25 through injection slot 26. The ion beam is squeezed towards the axis by an increasing voltage on a central electrode 27. Due to temporal and spatial focusing at the injection slot 26, ions start coherent axial oscillations. These oscillations produce image currents that are amplified and processed. Further details of the electrostatic trap apparatus 25 are described in International Application Publication WO 02/078046, U.S. Pat. No. 5,886,346, U.S. Pat. No. 6,872,938. The ion optics assembly 17, curved quadrupole trap 18 and associated ion optics are enclosed in a housing 30 which is evacuated in operation of the system.

The system 15 (FIG. 1A) further comprises reaction cell 23, which may comprise a collision cell (such as an octopole) that is enclosed in a gas tight shroud 24 and that is aligned to the curved quadrupole trap 141. The reaction cell 23, when used as a collision cell, may be supplied with an RF voltage of which the DC offset can be varied. A collision gas line (not shown) may be attached and the cell is pressurized with nitrogen or any) gas.

Higher energy collisions (HCD) may take place in the system 15 as follows: Ions are transferred to the curved quadrupole trap 18. The curved quadrupole trap is held at ground potential. For HCD, ions are emitted from the curved quadrupole trap 18 to the octopole of the reaction cell 23 by setting a voltage on a trap lens. Ions collide with the gas in the reaction cell 23 at an experimentally variable energy which may be represented as a relative energy depending on the ion mass, charge, and also the nature of the collision gas (i.e., a normalized collision energy). Thereafter, the product ions are transferred from the reaction cell back to the curved quadrupole trap by raising the potential of the octopole. A short time delay (for instance 30 ms) is used to ensure that all of the ions are transferred. In the final step, ions are ejected from the curved quadrupole trap 18 into the Orbitrap analyzer 25 as described previously.

The mass spectrometer system 15 illustrated in FIG. 1A lacks a mass filtering step and, instead, causes fragmentation of all precursor ions at once, without first selecting particular precursor ions to fragment. Accordingly, conventional tandem mass spectrometry experiments, as described above, are not generally performed using a system such at that illustrated in FIG. 1A. Instead, the equivalent of a tandem mass spectrometry experiment is performed as follows: (a) a first sample of ions (comprising a plurality of types of ions) produced from an eluting chemical compound are transferred to and captured by the curved quadrupole trap 18; (h) the first sample of ions is transferred to the Orbitrap analyzer 25 as described above for analysis, thereby producing a “full-scan” of the ions; (c) after the first sample of ions has been emptied from the curved quadrupole trap 18, a second sample of ions from the same chemical compound are transferred through the curved quadrupole trap 18 to the reaction cell 23; (d) in the reaction cell, a plurality of different types of fragment ions are formed from each of the plurality of ion types of the second sample of the chemical compound; (e) once the Orbitrap analyzer 25 has been purged of the first sample of ions, the fragment ions are transferred back quadrupole trap 18 and then to the Orbitrap analyzer 25 for analysis as described above. Such “all-ions-fragmentation scanning” provides a potential multiplexing advantage, but only if the analysis firmware or software can successfully extract precursor-product relationships between the thousands of ions generated in the all-ions-fragmentation scan and the additional thousands of ions present in the full-MS precursor scan.

FIG. 1B is a schematic illustration of an example of a general conventional mass spectrometer system 400 capable of providing tandem mass spectrometry. As illustrated in FIG. 1B, the mass spectrometer system 400 is a triple-quadrupole system comprising a first quadrupole device 433, a second quadrupole device 436 and a third quadrupole device 439, the last of which is a mass analyzer comprising one or more ion detectors 448. The first, second and third quadrupole devices may be denoted as, using common terminology, as Q1, Q2 and Q3, respectively.

The mass spectrometer system 400 comprises an electrospray ion source (ESI) 412 housed in an ionization chamber 424. The ESI source 412 is connected so as to receive a liquid comprising analyte compounds from a chromatography system (not shown) through fluid tubing line 402. As but one example, an atmospheric pressure electrospray source is illustrated. The electrospray ion source 412 forms charged particles 409 (either free ions or charged liquid droplets that may be desolvated so as to release ions) representative of the sample. The emitted droplets or ions are entrained in a background or sheath gas that serves to desolvate the droplets as well as to carry the charged particles into a first intermediate-pressure chamber 418 which is maintained at a lower pressure than the pressure of the ionization chamber 424 but at a higher pressure than the downstream chambers of the mass spectrometer system. The ion source 412 may be provided as a “heated electrospray” (H-ESI) ion source comprising a heater that heats the sheath gas that surrounds the droplets so as to provide more efficient desolvation. The charged particles may be transported through an ion transfer tube 416 that passes through a first partition element, or wall 415a into the first intermediate-pressure chamber 418. The ion transfer tube 416 may be physically coupled to a heating element or block 423 that provides heat to the gas and entrained particles in the ion transfer tube so as to aid in desolvation of charged droplets so as to thereby release free ions.

The free ions are subsequently transported through the intermediate-pressure chambers 418 and 425 of successively lower pressure in the direction of ion travel. A second plate or partition element or wall 415b separates the first intermediate-pressure chamber 418 from the second intermediate-pressure chamber 425. Likewise, a third plate or partition element or wall 415c separates the second intermediate-pressure region 425 from the high-vacuum chamber 426 that houses a mass analyzer 439 component of the mass spectrometer system. A first ion optical assembly 407a provides an electric field that guides and focuses the ion stream leaving ion transfer tube 416 through an aperture 422 in the second partition element or wall 415b that may be an aperture of a skimmer 421. A second ion optical assembly 407b may be provided so as to transfer or guide ions to an aperture 427 in the third plate or partition element or wall 415c and, similarly, another ion optical assembly 407c may be provided in the high vacuum chamber 426 containing a mass analyzer 439. The ion optical assemblies or lenses 407a-407c may comprise transfer elements, such as, for instance a multipole ion guide, so as to direct the ions through aperture 422 and into the mass analyzer 439. The mass analyzer 439 comprises one or more detectors 448 whose output can be displayed as a mass spectrum. Vacuum ports 413, 417 and 419 may be used for evacuation of the various vacuum chambers.

The mass spectrometer system 400 is in electronic communication with a programmable processor 405 or other electronic controller which includes hardware and/or software logic for performing data analysis and control functions. Such programmable processor may be implemented in any suitable form, such as one or a combination of specialized or general purpose processors, field-programmable gate arrays, and application-specific circuitry. In operation, the programmable processor effects desired functions of the mass spectrometer system (e.g., analytical scans, isolation, and dissociation) by adjusting voltages (for instance, RF, DC and AC voltages) applied to the various electrodes of ion optical assemblies 407a-407c and quadrapoles or mass analyzers 433, 436 and 439, and also receives and processes signals from detectors 448. The programmable processor 405 may be additionally configured to store and run data-dependent methods in which output actions are selected and executed in real time based on the application of input criteria to the acquired mass spectral data. The data-dependent methods, as well as the other control and data analysis functions, will typically be encoded in software or firmware instructions executed by programmable processor. A power source 408 supplies an RF voltage to electrodes of the devices and a voltage source 401 is configured to supply DC voltages to predetermined devices.

A lens stack 434 disposed at the ion entrance to the second quadrupole device 436 may be used to provide a first voltage point along the ions' path. The lens stack 434 may be used in conjunction with ion optical elements along the path after stack 434 to impart additional kinetic energy to the ions. The additional kinetic energy is utilized in order to effect collisions between ions and neutral gas molecules within the second quadrupole device 436. If collisions are desired, the voltage of all ion optical elements (not shown) after lens stack 434 are lowered relative to lens stack 434 so as to provide a potential energy difference which imparts the necessary kinetic energy.

Various modes of operation of the triple quadrupole system 400 are known. In some modes of operation, the first quadrupole device is operated as an ion trap which is capable of retaining and isolating selected precursor ions (that is, ions of a certain mass-to-charge ratio, m/z) which are then transported to the second quadrupole device 436. More commonly, the first quadrupole device may be operated as a mass filter such that only ions having a certain restricted range of mass-to-charge ratios are transmitted therethrough while ions having other mass-to-charge ratios are ejected away from the ion path 445. In many modes of operation, the second quadrupole device is employed as a fragmentation device or collision cell which causes collision induced fragmentation of precursor ions through interaction with molecules of an inert collision as introduced through tube 435 into a collision cell chamber 437. The second quadrupole 436 may be operated as an RF-only device which functions as an ion transmission device for a broad range of mass-to-charge ratios. In an alternative mode of operation, the second quadrupole may be operated as a second ion trap. The precursor and/or fragment ions are transmitted from the second quadrupole device 436 to the third quadrupole device 439 for mass analysis of the various ions.

FIG. 2 is a perspective view of a three-dimensional graph 1000 of hypothetical LC/MS data. As is common in the representation of such data, the variables time and mass (or mass-to-charge ratio, m/z) are depicted on the “floor” of the perspective diagram and the variable representing ion abundance (for instance, detected ion current) is plotted in the “vertical” dimension of the graph. Thus, ion abundance is represented as a function of the other two variables, this function comprising a variably shaped surface above the “floor”. Each set of peaks dispersed and in line parallel to the m/z axis represents the various ion types produced by the ionization of a single eluting, analyte (or, possibly, of fortuitously co-eluting, analytes) at a restricted range of time. In a well-designed chromatographic experiment, each analyte of a mixture will elute from the column (thereby to be mass analyzed) within a particular diagnostic time range. Consequently, either a single peak or a line of mass-separated peaks, each such peak representing a particular ion produced by the eluting analyte, is expected at each elution time (or retention time) range.

For clarity, only a very small number of peaks are illustrated in FIG. 2. In practice, data obtained by a chromatography-mass spectrometry experiment may comprise a very large volume of data. A mass spectrometer may generate a complete “scan” over an entire mass range of interest in a matter of tens to hundreds of milliseconds. As a result, up to several hundred complete mass spectra may be generated every second. Further, the various analytes may elute over a time range of several minutes to several tens of minutes, depending on the complexity of the mixture under analysis and the range of retention times represented.

When the chromatography-mass spectrometry experiment and data generation are performed by a mass spectrometer system that performs both all-ion precursor ion scanning and all-ions product ion scanning, the different scanning types alternating or interleaved with one another, then the data for each eluting constituent will logically comprise two data subsets, each of which is similar to the data set illustrated in FIG. 2. One of these data subsets will contain the data for the precursor ions and the other data subset will contain the data for the product ions. Such a situation is illustrated schematically in FIGS. 3A and 3C, discussed in greater detail in following paragraphs.

In many instances, the data set containing the product ion peaks will also contain some peaks corresponding to residual un-fragmented or un-reacted precursor ions. Some experimental approaches taught in this document make use of this phenomenon so as to eliminate one or more of the all-ion precursor ion scanning steps. For example, FIG. 3D schematically illustrates hypothetical results for an experimental setup in which no precursor scanning steps are performed. Instead, in the hypothetical experimental scenario corresponding to FIG. 3D, all ions are sent to a reaction cell in which fragmentation occurs and, subsequently, the contents of the fragmentation cell are analyzed after each such fragmentation sequence. Accordingly, the fragment ion peaks f1, f2, f3 and f4 are dearly represented in FIG. 3D. Because of incomplete fragmentation, however, the precursor-ion peaks p1, p2, p3 and p4 remain discernable in the data, albeit at reduced intensities.

Returning to the discussion of FIG. 2, the data depicted in FIG. 2 may comprise an entire stored data file representing results of a prior experiment. Alternatively, the data represent a portion of a larger data set in the process of being acquired by an LC/MS instrument. For instance, the data depicted in FIG. 2 may comprise recently collected data held in temporary computer readable memory, such as a memory buffer, and corresponding to an analysis time window, Δt, upon which calculations are being formed while, at the same time, newer data is being collected. Such newer, not-yet-analyzed data is represented, in time and m/z space, by region 1034 and the data actually being collected is represented by the line t=t₀. Older data which has already been analyzed by methods of the present teachings and which has possibly been stored to a permanent computer readable medium, is represented by region 1036. With such manner of operation, methods in accordance with the present teachings are carried out in near-real-time on an apparatus used to collect the data or using a processor (such as a computer processor) closely linked to the apparatus used to collect the data.

Operationally, data such as that illustrated in FIG. 2 is collected as separate mass spectra (also referred to herein as “scans”), each mass spectrum (scan) corresponding to a particular respective time point. Such mass spectra may be envisioned as residing within planes parallel to the plane indicated by the trace lines 1010 in FIG. 2 or parallel to the lines rt1, rt2, rt3 and rt4 in FIG. 3A (each of which illustrates a different respective retention time). As illustrated in FIG. 3A, each precursor-ion scan corresponds to a respective product-ion scan. Once at least a portion of data has been collected, such as the data in region 1932 in FIG. 2, then the information in the data portion may be logically re-organized as extracted ion chromatograms (or, at least portions thereof). Each such extracted ion chromatogram (XIC) may be envisioned as a cross section through the data in a plane parallel to the plane indicated by trace lines 1020 in FIG. 2 or parallel to the lines m1, m2, m3, m4, mf1, mf2, and mf3 in FIG. 3A. Hypothetical extracted ion chromatograms are shown as dotted lines in FIG. 3A and FIG. 3B. Hypothetical Each XIC represents the elution profile, in time, of ions of a particular mass-to-charge range. Hypothetical extracted ion chromatograms of precursor ions and product ions are shown as solid lines and dotted lines, respectively, in FIGS. 3C and 3D.

It is known (for example, international patent application publication WO2005/113830 A2 or United States Pre-Grant Publication 2012/0158318 A1, the latter of which relates to an application assigned to the assignee of the instant invention) that by correlating XIC peak shapes among precursor-ion and product-ion scans, as produced by an instrument—such at those illustrated in FIG. 1—that interleaves all-ions precursor-ion scans with fully fragmented product-ion scans, reconstructed MS2 spectra can be produced that include many, if not all, of the ions one would expect from a conventional tandem mass spectrometry experiment. The advantage of the all-ions fragmentation (AIF) approach is in multiplexing all the potential precursors are fragmented at the same time, and unexpected precursor product spectra can be extracted from the multiplexed data without having to re-run the experiment several times, each time isolating just one or a few precursor ions.

The XIC representation of the data as is schematically illustrated in FIG. 3 is useful for understanding the methods of the present teachings. Several schematic extracted ion chromatograms are illustrated in FIG. 3A by dotted lines residing at respective mass-to-charge values indicated by sections m1, m2, m3 and m4 as well as at mass-to-charge values indicated by sections mf1, mf2 and mf3. These profiles include several example peaks. The illustrated precursor scan peaks are peak p1 at coordinates (rt1, m4), peak p2 at coordinates (rt2, m3), peak p3 at coordinates (rt3, m1) and peak p4 at coordinates (rt4, m2). Three product-ion scan peaks are also illustrated: peak f1 at coordinates (rt1, mf3), peak 12 at coordinates (rt2, mf1) and peak f4 at coordinates (rt4, mf2).

FIG. 3A illustrates an idealized situation in which related precursor and product ions are shown as occurring simultaneously. However, as described above with respect to the operation of the spectrometer system 15 (FIG. 1A) and the mass spectrometer system 400 (FIG. 1B), the precursor-ion and product-ion scans do not generally occur exactly simultaneously and, thus, may alternate in time. Thus, in a more realistic situation, as illustrated in FIG. 3C, each product-ion scan is offset in time, relative to the scan of the associated precursor ions, by a time delay increment Δτ. The system 15 illustrated in FIG. 1A is capable of repeating the precursor scan and product ion scan sequence five or more times for compounds that elute over a period of 1 second (that is, 10 total scans per second). Thus, even though precursor ion and product ion scans are not coincident in time, there are generally a sufficient number of precursor ion scans and product ion scans to permit discernment of the profiles of the peaks.

Subsequent to execution of the methods discussed following sections of this disclosure, each XIC is defined by a set of synthetic peaks calculated by those methods. The hypothetical synthetic extracted ion chromatograms schematically shown in FIG. 3A illustrate elution of various ionized chemical constituents at closely-spaced times rt1, rt2, rt3 and rt4. Although illustrated as separated times, one or more of the times rt1 rt2, rt3 and rt4 could even be identical to one another, such that the various chemical constituents are co-eluting constituents. It should be noted that the mass scale (i.e., m/z scale) relating to product ion scans in FIG. 3A is not a simple extension of the mass scale relating respectively relating, to precursor ion scans in fact, the two mass scales may overlap one another but are not necessarily identical to one another.

The set of extracted ion chromatograms indicated by sections m1, m2, m3 and m4 in FIG. 3A could be algebraically summed so as to yield a reconstructed total ion chromatogram. One such hypothetical total ion chromatogram (TIC) is shown as the intensity-versus-time graph 300 presented in the lowermost portion of FIG. 3E. Dashed lead lines in FIG. 3E illustrate how the TIC graph 300 relates to the time-resolved three-dimensional depictions of scan data occurring at retention times rt1, rt2, rt3 and rt4. Peak 305 in the total ion chromatogram (TIC) 300 represents the combined contributions of mass spectrometer peaks generated in scans at retention times rte and rt2. Likewise, peak 307 represents the combined contributions of mass spectrometer peaks generated in scans at retention times rt3 and rt4.

Reconstructed mass spectra (scans) are illustrated by the solid-line curves parallel to the m/z axes in FIG. 3A and FIG. 3E. The reconstructed scans may be generated by including all ion masses that produce a chromatographic peak at the time corresponding to the scan, lie within the peak width of said peak, and were collected under identical scan filters. Thus, every ion present in a reconstructed scan is known to contribute to a chromatographic peak, whose apex is nearby but not necessarily at the time of the scan.

The inventors have determined that it is not always necessary to include the full precursor-ion scan in a mass spectrometry experiment. In many cases, the precursor ion is not completely fragmented and still appears in and can be monitored from an all-ions product-ion (AIF) scan. By not requiring alternate precursor-ion and product-ion scans, the effective scan rate for the AIF scans is doubled, greatly improving the detail recorded in the XIC peak shape and possibly saving computer memory resources. A more precisely recorded peak shape produces higher correlation discrimination; related ions may not have a significantly higher correlation score, but unrelated ions will have lower scores.

The inventors have additionally realized that, in some other cases, the precursor ions may not survive the fragmentation process and, as a result, their signals may not be present in the product-ion spectra. Also, the unambiguous identification of precursor signals may not be possible from the information obtained. The addition of periodically interspersed precursor-ion scans (i.e., not involving fragmentation) will be valuable in such instances and will supply additional needed information. In other cases, additional information may be available, such as known or user-specified product/precursor associations. In yet other cases, chromatographic separation may poor and may not allow for reliable decomposition of overlapped elution profiles. In such instances, correlations based upon plausible neutral losses or expected fragmentation mechanisms may be more appropriate than correlations based on elution profiles. Accordingly, the inventors have realized that novel methods of acquiring and analyzing all-ions fragmentation data, such methods including multiple analysis approaches, are required.

### SUMMARY

Novel mass spectral analysis methods employing multiple approaches for extracting single-component fragmentation spectra from multiplexed product-ion spectra (also known as AIF spectra) are described. A feature of the various approaches is that the number of fragment-ion (or product ion) mass spectra (“scans”) that are obtained is not necessarily equivalent to the number of precursor ion scans, if any. In many cases, the number of precursor ion mass spectra (i.e., so-called “full scans”) obtained during a given time period may be fewer than the number of product-ion or fragment-ion mass spectra obtained during the same time period. In fact, the ratio, ρ, of the number of precursor-ion scans to the number of product-ion scans performed during particular time period may, in some cases, be equal to zero (i.e., ρ=0). In many cases, the value of ρ may vary between samples or even during the analysis of a single sample, depending on the quality of chromatographic separation of analytes, the speed of making mass spectral measurements, as well as other experimental conditions. Likewise, the particular approach employed for analyzing the multiplexed mass spectral data may also vary during or between analyses may also vary according to similar factors. Accordingly, some basic approaches are:

Approach 1—In this approach, product-ion (fragmentation scan) data are collected and it is determined if a putative residual precursor m/z value for each individual fragmentation spectrum is present and identifiable. In this approach, precursor-ion scans may not be necessary, but a single such scan per component peak (in a data-dependent mode) may nonetheless be useful. This approach relies on comparisons of the extracted ion chromatogram (XIC) for all ions present in the AIF scans, selects some ions as precursor ions (by analysis) and proposes related ions in the AIF scan as product ions based on XIC peak shape. This approach may also employ determining if neutral loss masses correspond to plausible chemical formulae (of the lost neutral molecules), especially if chromatographic separation is poor.

Approach 2—An approach as described in “Approach 1” above is employed, with the addition of the following: the identification, or confirmation of precursor m/z values is made by collecting a single precursor-ion mass spectrum (a full-scan spectrum) for each component elution peak observed via a data-dependent mechanism.

Approach 3—An approach as described in “Approach 1” above is employed with the addition of the following: the identification or confirmation of the precursor m/z values is made by acquiring occasional interleaved precursor-ion spectra.

Approach 4—An approach as described in “Approach 1” above is employed with the addition of the following: user input with a list of putative target precursor ions (which may or may-not include retention-time information as well) are correlated to the fragmentation data via neutral loss or elemental composition information.

Approach 5—An approach as described in “Approach 1” above is employed with the addition of the following: putative precursor m/z values are identified through the use of “golden-pairs” of fragment-ion signals.

Approach 6—Combined scanning—The instrument is set to alternate between precursor-ion scanning and product-ion scanning. At the end of the acquisition (or during if possible) the scans are collected, combined and processed by correlational analysis (for grouping related ions) and neutral loss analysis (for parent ion identification).

The above list of approaches is not meant to be exhaustive and features from each approach may be combined in various ways, with not every feature necessarily included in every combination. The exact approach employed in any particular experimental situation may depend on a number of instrumental and sample-related variables. In some embodiments, the methods taught herein may be employed automatically and without user intervention as data as being collected in order to generate highest-quality data.

According to a first aspect of the present teachings, there is provided a method for acquiring and interpreting tandem mass spectra of a plurality of compounds that are introduced into a mass spectrometer from a chromatograph, said method comprising: (a) repeatedly performing, during a time period, the steps of: (a1) ionizing the plurality of compounds as they elute from the chromatograph so as to generate a plurality of precursor ion species therefrom using an ion source of the mass spectrometer; (a2) introducing the plurality of precursor ions into a fragmentation cell of the mass spectrometer operated at constant fragmentation energy so as to generate a plurality of product-ion species from all or a portion of each of the plurality of precursor ion species; and (a3) generating a mass spectrum of the plurality of product-ion species; and (b) recognizing matches between certain of the product ion species generated during the time period based on correlations between elution profiles of the product ion species determined from the plurality of generated mass spectra.

According to this first aspect of the present teachings, mass spectra of precursor ions are not obtained in the absence of fragmentation. Various embodiments may further comprise identifying at least one of the compounds from a set of matched product ion species. Various embodiments may further comprise recognizing a mass spectral peak of a residual unfragmented precursor ion species from the plurality of mass spectra generated in step (a3). Various other embodiments may comprise receiving a mass of a target precursor ion species from a user. Various other embodiments may include the step of determining an elution profile of a residual unfragmented precursor ion species from the plurality of generated mass spectra.

Various of the embodiments in which a residual unfragmented precursor ion is determined may include the further step of: recognizing a match between the residual unfragmented precursor ion species and at least one product ion species based on at least one correlation between the elution profile of the residual unfragmented precursor ion species and an elution profile of the at least one product ion species.

Various embodiments may comprise the steps of: determining a mass of the residual unfragmented precursor ion species; and recognizing a match between the residual unfragmented precursor ion species and a product ion species based on a correspondence of a mass difference between the residual unfragmented precursor ion species and the product ion species to a loss of a valid neutral molecule.

Various embodiments may comprise the step of recognizing a match between a precursor ion species and a set of product ion species whose non-adducted masses sum to the non-adducted mass of the individual precursor ion species.

According, to a second aspect of the present teachings, a method for acquiring and interpreting tandem mass spectra of a plurality of compounds that are introduced into a mass spectrometer from a chromatograph is provided, the method comprising: (a) repeatedly performing a total of m times, during a first time period, the steps of: (a1) ionizing the plurality of compounds as they elute from the chromatograph so as to generate a plurality of precursor ion species therefrom using an ion source of the mass spectrometer; (a2) introducing the plurality of precursor ions into a fragmentation or reaction cell of the mass spectrometer so as to generate a plurality of product-ion species from all or a portion of each of the plurality of precursor ion species; and (a3) generating a mass spectrum of the plurality of product-ion species; (b) generating, during the first time period, a total number n of mass spectra of the plurality of precursor ion species prior to their introduction into the fragmentation or reaction cell, wherein n<m; and (c) recognizing matches between certain of the precursor ion species and certain of the product ion species generated during the first time period based on either correlations between elution profiles of the ion species determined from the plurality of generated mass spectra or correspondences of mass differences between ion species to losses of valid neutral molecules.

According to a third aspect of the present teachings, a method for acquiring and interpreting tandem mass spectra of a plurality of compounds that are introduced into a mass spectrometer from a chromatograph is provided, the method comprising: (a) repeatedly performing, during a time period, the steps of: (a1) ionizing the plurality of compounds as they elute from the chromatograph so as to generate a plurality of precursor ion species therefrom using an ion source of the mass spectrometer; (a2) introducing the plurality of precursor ions into a fragmentation or reaction cell of the mass spectrometer so as to generate a plurality of product-ion species from a portion of each of the plurality of precursor ion species; and (a3) introducing the plurality of product-ion species and a residual portion of the precursor ion species into a mass analyzer of the mass spectrometer so as to generate a mass spectrum thereof; (b) recognizing matches between precursor ion species and product ion species generated during the time period based on either correlations between elution profiles of the ion species determined from the plurality of generated mass spectra or observed correspondences of mass differences between ion species to losses of valid neutral molecules.

According to another aspect of the present teachings, there is provided an apparatus comprising: (a) a chromatograph; (b) a mass spectrometer receiving compounds that elute from the chromatograph, the mass spectrometer comprising: (i) an ionization source configured to receive, from the chromatograph, the eluting compounds and to generate ions comprising a plurality of precursor ion species therefrom; (ii) a fragmentation or other reaction cell configured so as to receive, from the ionization source, the plurality of precursor ion species and to generate product ions therefrom comprising a plurality of product ion species; and (iii) a mass analyzer configured to receive the plurality of precursor ion species and the plurality of product ion species and to generate mass spectra thereof; and (c) an electronic controller electronically coupled to the mass spectrometer so as to control the operation thereof and to receive mass spectral data therefrom, the electronic, controller comprising program instructions operable to cause the electronic controller to: (i) cause the mass spectrometer to repeatedly perform, during a time period, the steps of ionizing the plurality of compounds as they elute from the chromatograph so as to generate a plurality of precursor ion species therefrom using the ion source, introducing the plurality of precursor ions into a fragmentation cell of the mass spectrometer operated at constant fragmentation energy so as to generate a plurality of product-ion species from all or a portion of each of the plurality of precursor ion species, and generating a mass spectrum of the plurality of product-ion species; and (ii) recognize matches between certain of the product ion species generated during the time period based on correlations between elution profiles of the product ion species determined from the plurality of generated mass spectra.

According to another aspect of the present teachings, there is provided an apparatus comprising: (a) a chromatograph; (b) a mass spectrometer receiving compounds that elute from the chromatograph, the mass spectrometer comprising: (i) an ionization source configured to receive, from the chromatograph, the eluting compounds and to generate ions comprising a plurality of precursor ion species therefrom; (ii) a fragmentation or other reaction cell configured so as to receive, from the ionization source, the plurality of precursor ion species and to generate product ions therefrom comprising a plurality of product ion species; and (iii) a mass analyzer configured to receive the plurality of precursor ion species and the plurality or product ion species and to generate mass spectra thereof; and (c) an electronic controller electronically coupled to the mass spectrometer so as to control the operation thereof and to receive mass spectral data therefrom, the electronic controller comprising program instructions operable to cause the electronic controller to: (i) cause the mass spectrometer to repeatedly perform, a total of m times during a time period, the steps of generating the precursor ion species by ionizing the plurality of compounds as they elute from the chromatograph, generating the plurality of product ion species from the plurality of precursor ion species in the fragmentation or reaction cell and mass analyzing the pluralities of precursor-ion and product-ion species; (ii) cause the mass spectrometer to generate, during the time period, a total number n of mass spectra of the plurality of precursor ion species prior to their introduction into the fragmentation or reaction cell, wherein n<m; and (iii) recognize matches between certain of the precursor ion species and certain of the product ion species generated during the time period based on correlations between elution profiles of the ion species or correspondences of mass differences between ion species to losses of valid neutral molecules.

According to still another aspect of the present teachings, there is provided an apparatus comprising: (a) a chromatograph; (b) a mass spectrometer receiving compounds that elute from the chromatograph, the mass spectrometer comprising: (i) an ionization source configured to receive, from the chromatograph, the eluting compounds and to generate ions comprising a plurality of precursor ion species therefrom; (ii) a fragmentation or other reaction cell configured so as to receive, from the ionization source, the plurality of precursor ion species and to generate therefrom product ions comprising a plurality of product ion species; and (iii) a mass analyzer configured to receive the plurality of precursor ion species and the plurality of product ion species and to generate mass spectra thereof; and (c) an electronic controller electronically coupled to the mass spectrometer so as to control the operation thereof and to receive mass spectral data therefrom, the electronic controller comprising program instructions operable to cause the electronic controller to: (i) cause the mass spectrometer to repeatedly perform the steps, during a time period, of generating the precursor ion species by ionizing the plurality of compounds as they elute from the chromatograph, generating the plurality of product ion species from a portion of the plurality of precursor ion species in the fragmentation or reaction cell and introducing the plurality of product-ion species and a residual portion of the precursor ion species into a mass analyzer of the mass spectrometer so as to generate a mass spectrum thereof; and (ii) recognize matches between certain of the precursor ion species and certain of the product ion species generated during the time period based on correlations between elution profiles of the ion species determined from the plurality of generated mass spectra or correspondences of mass differences between ion species to losses of valid neutral molecules.

### BRIEF DESCRIPTION OF THE DRAWINGS

The above noted and various other aspects of the present invention will become apparent from the following description which is given by way of example only and with reference to the accompanying drawings, not drawn to scale, in which:

FIG. 1A is a schematic illustration of an example of a mass spectrometer system which may be employed in the practice of the present teachings, wherein the mass spectrometer comprises an electrostatic trap mass analyzer such as an Orbitrap™ mass analyzer;

FIG. 1B is a schematic illustration of a second example of a mass spectrometer system which may be employed in the practice of the present teachings, wherein the mass spectrometer comprises a triple quadrupole mass spectrometer;

FIG. 2 is a perspective view of a three-dimensional graph of chromatography-mass spectrometry data, in which the variables are time, mass (or mass-to-charge ratio, m/z) and ion abundance;

FIG. 3A is a perspective view of a three-dimensional graph of chromatography-mass spectrometry data showing four hypothetical mass spectra of precursor ions and corresponding mass spectra of product ions and showing hypothetical extracted ion chromatograms (Ws) for several different values of mass-to-charge ratio;

FIG. 3B is a perspective view of a portion of the three-dimensional graph of FIG. 3A showing selected peaks as extracted ion chromatograms;

FIG. 3B is another representation of the three-dimensional graph of FIG. 3A showing interleaving between spectra of precursor ions and spectra of product ions;

FIG. 3D is a perspective view of a three-dimensional graph of chromatography-mass spectrometry data of FIG. 3A, showing scans in which the precursor-ion and product-ion data are obtained simultaneously as a result of only a portion of the precursor ions being fragmented so as to generate the product ions;

FIG. 3E is an illustration of an example of how a total ion chromatogram may relate to raw mass spectrometry data;

FIG. 4 is a schematic diagram of a system for generating and automatically analyzing chromatography/mass spectrometry spectra in accordance with the present teachings;

FIG. 5A-5B provide a flowchart of a method for acquiring and interpreting mass spectral data incorporating choices between multiple data collection and analysis approaches in accordance with the present teachings;

FIGS. 6A-6B provide a flowchart of a method for automatically recognizing correlations between elution profiles of all-ions precursor ions and all-ions-fragmentation product ions in accordance with the present teachings;

FIGS. 7A-7C are graphical examples of discrimination of peaks of interest from noise peaks in an ion chromatogram;

FIG. 8 is a flowchart of a method for automated spectral peak detection and quantification;

FIG. 9 is a flowchart of a method for automatically removing baseline features and estimating background noise from spectral data;

FIG. 10 is a graph of an example of the variation of the calculated area underneath a baseline-corrected spectral curve as a function of the order of polynomial used in fitting the baseline to a polynomial function;

FIG. 11 is an example of a preliminary baseline corrected spectral curve prior to fitting the end regions to exponential functions and an example of the baseline comprising exponential fit functions;

FIG. 12 is a flowchart of a method for automated spectral peak detection and quantification;

FIG. 13 a graph of a hypothetical skewed spectral peak depicting a method for obtaining three points on the spectral peak to be used in an initial estimate of skew and for preliminary peak fitting;

FIG. 14 a graph of a set of gamma distribution functions having different values of shape parameter M, illustrating a fashion by such functions may be used to synthetically fit skewed spectral peaks;

FIG. 15 is a flowchart illustrating a method for choosing between peak shapes used for fitting;

FIG. 16 is a perspective view of a portion of the three-dimensional graph of FIG. 3A showing selected peaks as mass scans;

FIG. 17 is a set of plots of several observed peak shapes in various extracted ion chromatograms obtained from LC/MS data covering the 1.7-second elution of a single mass chromatographic peak (e.g., a total ion chromatogram peak) of a 500 nM solution of the drug Buspirone; and

FIG. 18 is a schematic illustration of two peaks having differing peak shapes illustrating a method of calculating a cross-correlation score as a dot product.

FIGS. 19A-19B provide a flowchart, of a method for generating automated correlations between all-ions precursor ions and all-ions-fragmentation product ions by recognizing losses;

FIGS. 20A-20B provide a flowchart of another method for generating automated correlations between all-ions precursor ions and all-ions-fragmentation product ions in accordance with the present teachings.

### DETAILED DESCRIPTION

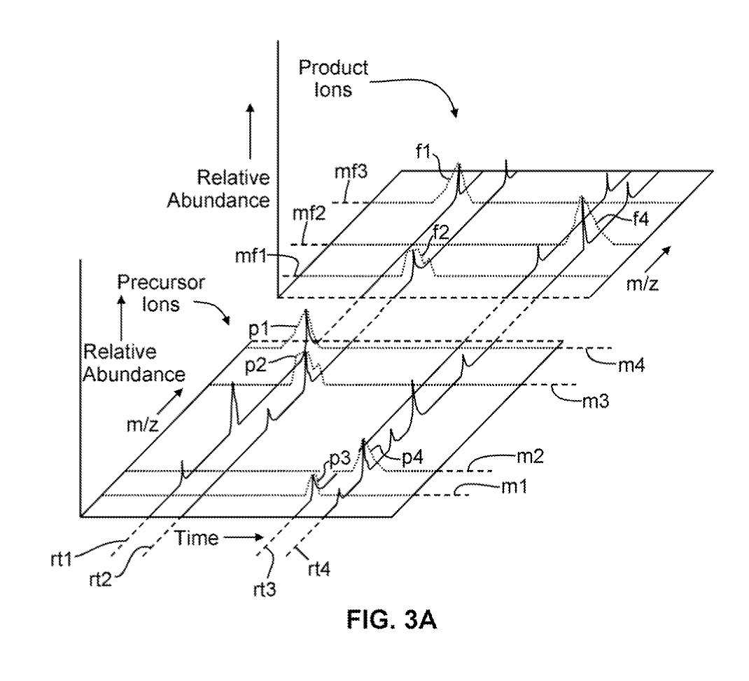

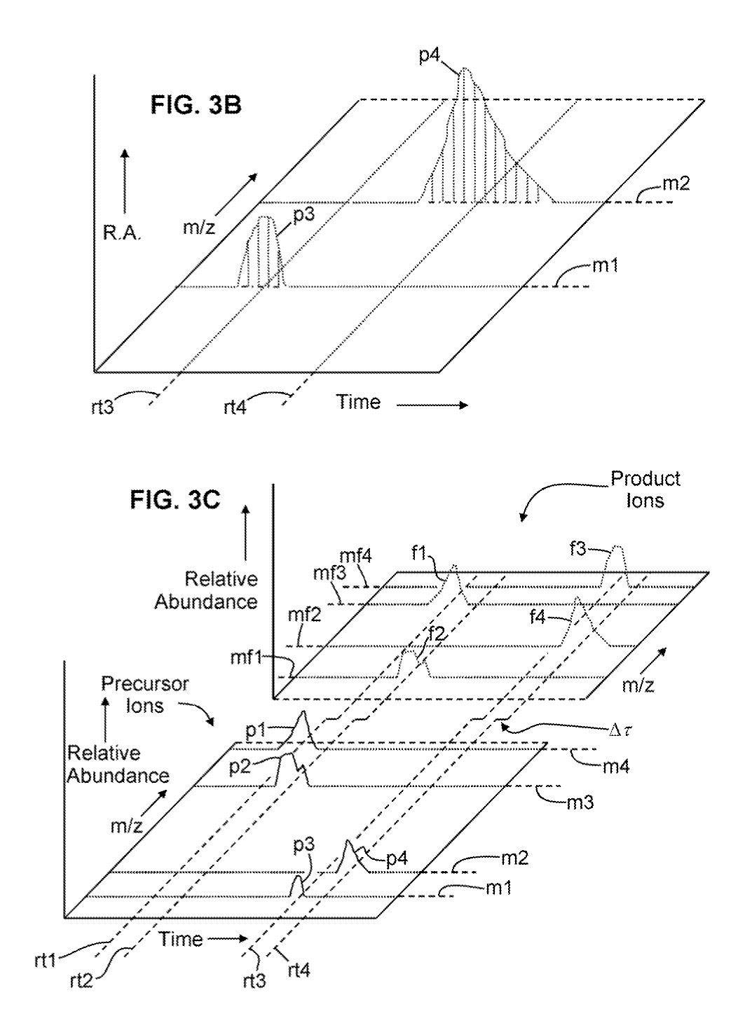

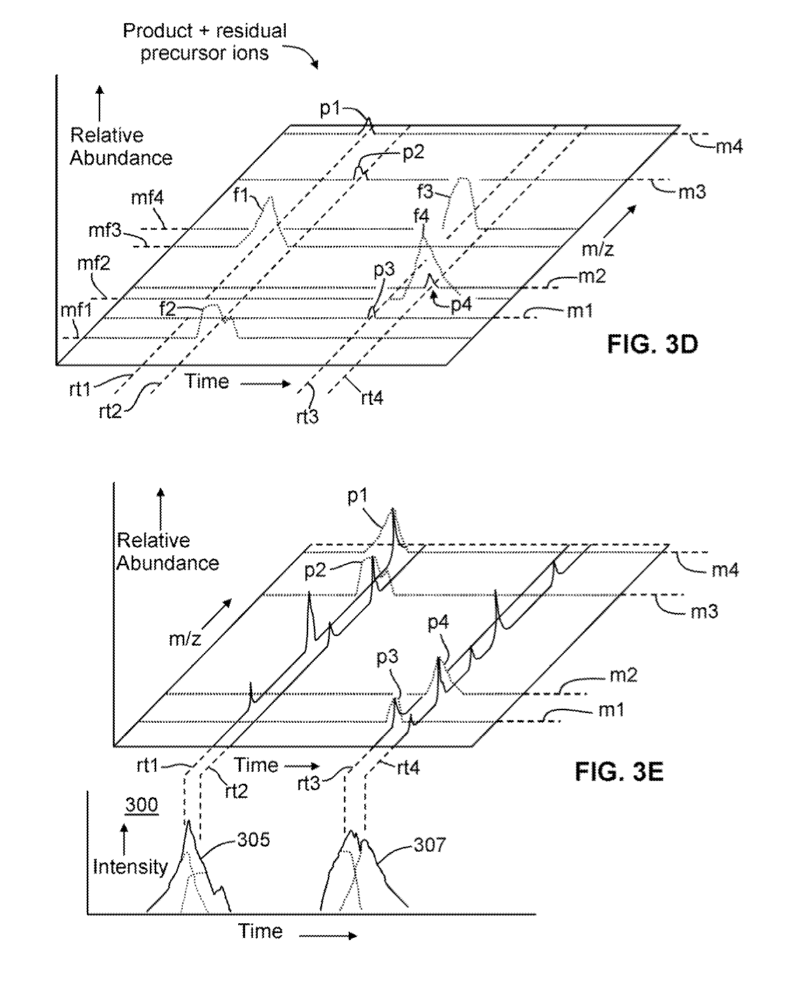

The present invention provides methods and apparatus for correlating precursor and product ions according to several alternative approaches, the choice of which may be instrument-dependent, sample dependent or data dependent. The automated methods and apparatus described herein do not require any user input or intervention. The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. The particular features and advantages of the invention will become more apparent with reference to the appended FIGS. 3-20, taken in conjunction with the following description.

### Section 1. General Considerations

Accurate identification of many organic molecules by mass spectrometry requires on fragmentation data including experimental data relating to precursor ions as well as data relating to the product ions generated during the fragmentation. All-ions fragmentation experiments, as discussed above, are essentially capable of performing multiple ion fragmentation experiments simultaneously, thereby significantly reducing the time required to analyze each sample in comparison to conventional selected reaction monitoring tandem mass spectrometry experiments. Such increased experimental efficiency is produced, however, at the cost of more-complexly-overlapped data results and consequent more-challenging data analysis.

Because of differences between samples, instrument configurations and available information, the procedures used to acquire and extract optimal information using all-ions fragmentation mass spectrometry may vary between experiments and even during a single experiment. Such variations may include variations in experimental parameters as well as variations in mathematical data analysis. Accordingly, the present disclosure describes multiple approaches for extracting single-component fragmentation spectra from multiplexed product-ion spectra (also known as AIF spectra) and provides methods for choosing among or even combining the various approaches. Some basic approaches are summarized in the following paragraphs.

In a first approach, product-ion (fragmentation scan) data are collected and it is determined if a putative residual precursor m/z value for each individual fragmentation spectrum is present and identifiable. In this approach, interleaved precursor-ion scans may not be necessary, but a single such scan per component peak (in a data-dependent mode) is useful. This approach relies on comparisons of the extracted ion chromatogram (XIC) for all ions present in the AIF scans, selects some ions as precursor ions (by analysis) and proposes related ions in the AIF scan as product ions based on XIC peak shape. This approach may also employ determining if neutral loss masses correspond to plausible chemical formulae (of the lost neutral molecules), especially if chromatographic separation is poor.

In a second approach, the steps as described in “Approach 1” above are employed and, further, the identification or confirmation of precursor m/z values is made by collecting a single precursor-ion mass spectrum (a full-scan spectrum) for each component elution peak observed via a data-dependent mechanism. In a third approach (Approach 3), the steps as described in “Approach 1” above are employed and, further, the identification or confirmation of the precursor m/z values is made by acquiring occasional interleaved precursor-ion spectra. In a fourth approach (Approach 4), the steps as described in “Approach 1” above are employed and, further, user input is employed so as to filter the results. The user input may include a list of putative target precursor ions (which may or may-not include retention-time information as well). In a fifth approach (Approach 5), the steps as described in “Approach 1” above are employed and, further, the putative precursor m/z values are identified through the use of “golden-pairs” of fragment-ion signals.

In Approach 6, combined scanning is employed. In this approach, a mass spectrometer instrument is set to alternate between precursor-ion scanning and product-ion scanning. At the end of the acquisition (or during if possible) the resulting interleaved scans are collected, combined and processed by correlational analysis (for grouping related ions) and neutral loss analysis (for parent ion identification).

One important experimental parameter which may vary according to the particular approach employed is ρ, the ratio of the number, n, of precursor-ion scans performed during a given time period to the number, m, of product ion scans performed during the same time period. As a practical matter, the parameter ρ will generally only vary between zero and unity, in accordance with experimental, sample-related, and other conditions. A value of ρ=1 corresponds to perfect interleaving of precursor-ion and product-ion scans.

If experimental conditions (for example, collision energy) and ion properties are such that complete fragmentation occurs (that is, no precursor survival), then the parameter ρ should be set at some value greater than zero so that precursor ions may be measured. However, if fragmentation is incomplete (some precursors survive the fragmentation process), then ρ may be set to zero in many instances. Nonetheless, if the quantity of fragmentation is poor, the parameter ρ may be set to some small positive value so that more fragmentation scans may be measured.

A slower data acquisition rate (instrumental scan repetition rate) may also lead to a choice of a small positive value for ρ, since product-ion scans may contain more diagnostic information than do precursor-ion scans. A faster data acquisition rate may permit an adequate number of both types of scans to be performed during elution of any component and, in such situations, ρ may be set at a greater value, up to ρ=1.

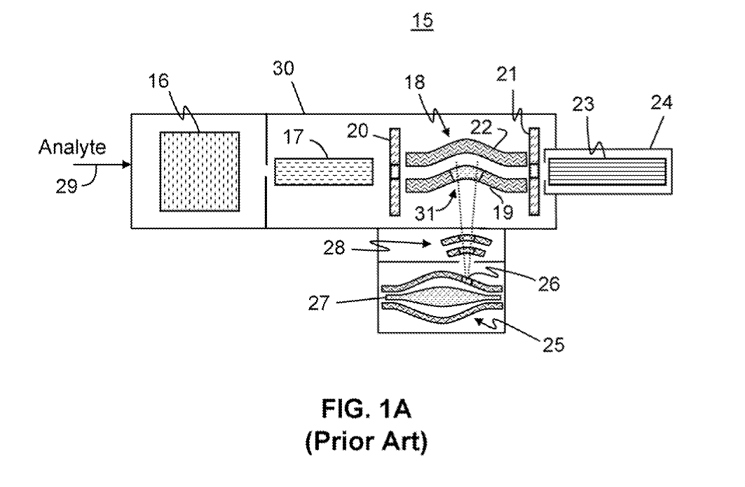

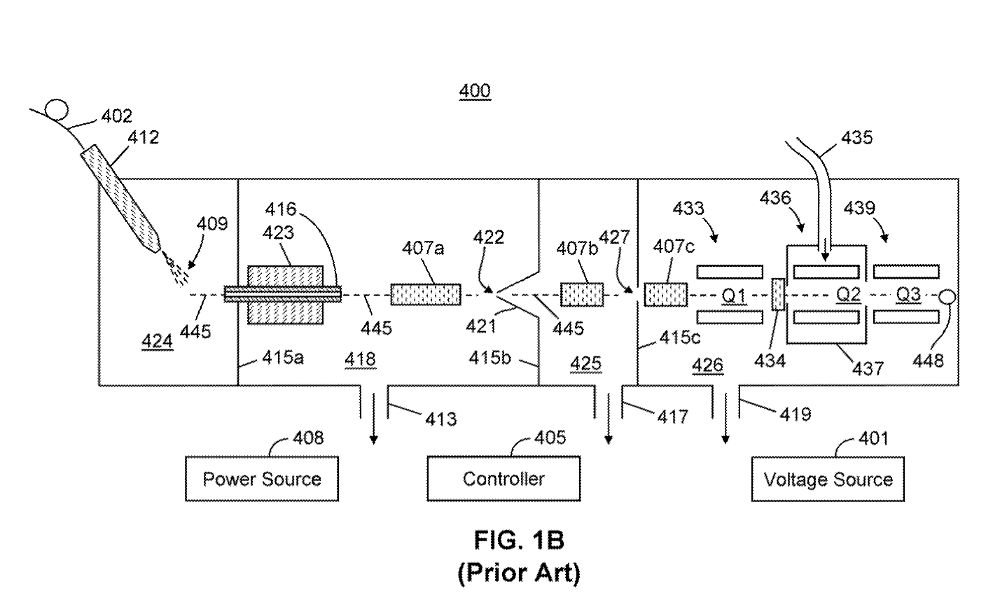

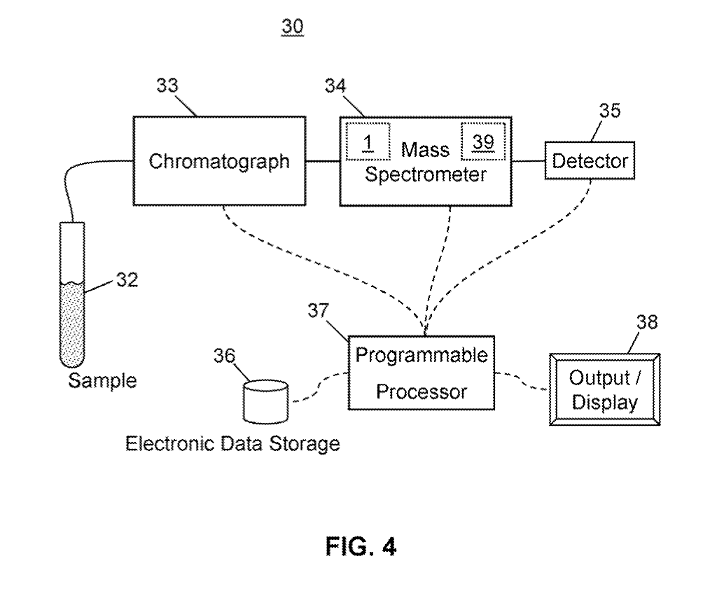

FIG. 4 is a schematic diagram of a general system 30 for generating and automatically analyzing chromatography/mass spectrometry spectra in accordance with the present teachings. A chromatograph 33, such as a liquid chromatograph, high-performance liquid chromatograph or ultra high performance liquid chromatograph or other type of chromatograph receives a sample 32 of an analyte mixture and at least partially separates the analyte mixture into individual chemical constituents, in accordance with well-known chromatographic principles. As a result, the at least partially separated chemical constituents are transferred to a mass spectrometer 34 at different respective times for mass analysis. As each chemical constituent is received by the mass spectrometer, it is ionized by an ionization source 1 of the mass spectrometer. The ionization source 1 may produce a plurality of ions (i.e., a plurality of precursor ions) comprising differing charges or masses from each chemical component. Thus, a plurality of ion types of differing mass-to-charge ratios may be produced for each chemical component, each such component eluting from the chromatograph at its own characteristic time. These various ion types are analyzed and detected by the mass spectrometer together with its detector 35 and, as a result, appropriately identified according to their various mass-to-charge ratios. As illustrated in FIG. 4, the mass spectrometer comprises a reaction cell 39 to fragment or cause other reactions of the precursor ions. As but one example, the reaction cell 23 shown in FIG. 1A as a component of the mass spectrometer system 15 is one example of a reaction cell. As is the situation for the system 15, the mass spectrometer 34 may lack a mass filtering step for selection of particular ions to introduce into the reaction cell. In such a situation, the reaction cell, instead, causes reactions to or fragmentation of all ions at once, a process herein referred to as “all-ions fragmentation”.

The present disclosure makes use of the terms “ion” (or “ions” in the plural) and “ion type” for “ion types” in the plural). For purposes of this disclosure, an “ion” is considered to be a single, solitary charged particle, without implied restriction based on chemical composition, mass, charge state, mass-to-charge (m/z) ratio, etc. A plurality of such charged particles comprises a collection of “ions”. An “ion type”, as used herein, refers to a category of ions—specifically, those ions having a given monoisotopic m/z ratio—and, most generally, includes a plurality of charged particles, all having the same monoisotopic in/z ratio. This usage includes, in the same ion type, those ions for which the only difference or differences are one or more isotopic substitutions. One of ordinary skill in the mass spectrometry arts will readily know how to recognize isotopic distribution patterns and how to relate or convert such distribution patterns to monoisotopic masses.

Still referring to FIG. 4, a programmable processor 37 is electronically coupled to the detector of the mass spectrometer and receives the data produced by the detector during chromatographic mass spectrometric analysis of the sample(s). The programmable processor may comprise a separate stand-alone computer or may simply comprise a circuit board or any other programmable logic device operated by either firmware or software. Optionally, the programmable processor may also be electronically coupled to the chromatograph and/or the mass spectrometer in order to transmit electronic control signals to one or the other of these instruments so as to control their operation. The nature of such control signals may possibly be determined in response to the data transmitted from the detector to the programmable processor or to the analysis of that data. The programmable processor may also be electronically coupled to a display or other output 38, for direct output of data or data analysis results to a user, or to electronic data storage 36.

The programmable processor shown in FIG. 4 is generally operable to, among other things: receive a mass spectrum from the chromatography/mass spectrometry apparatus; generate and evaluate a plurality of extracted ion chromatograms (XICs) representing respective mass-to-charge ratios within the mass spectrum; automatically subtract a baseline from each such XIC so as to generate a plurality of baseline-corrected XICs; automatically detect and characterize all spectral peaks occurring above a noise level in each baseline-corrected XIC; perform a cross-correlation calculation between each pair of detected peaks; and report or record information relating to the peaks, to the cross-correlations between the peaks.

### Section 2. High-Level Methods

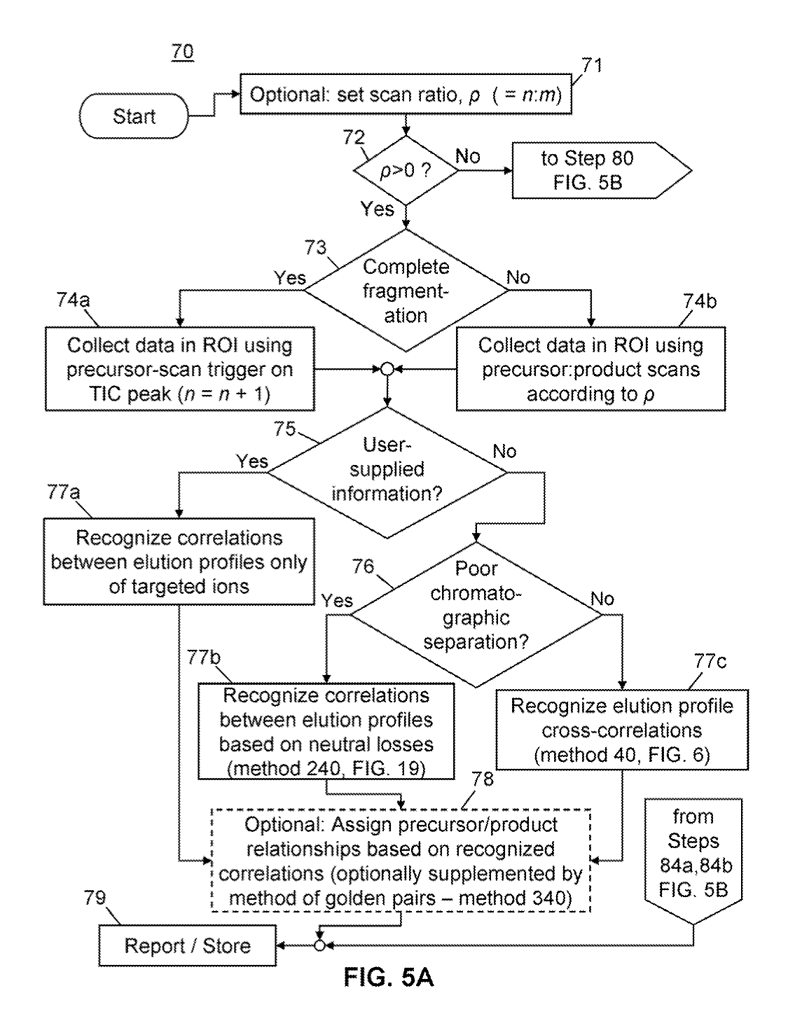

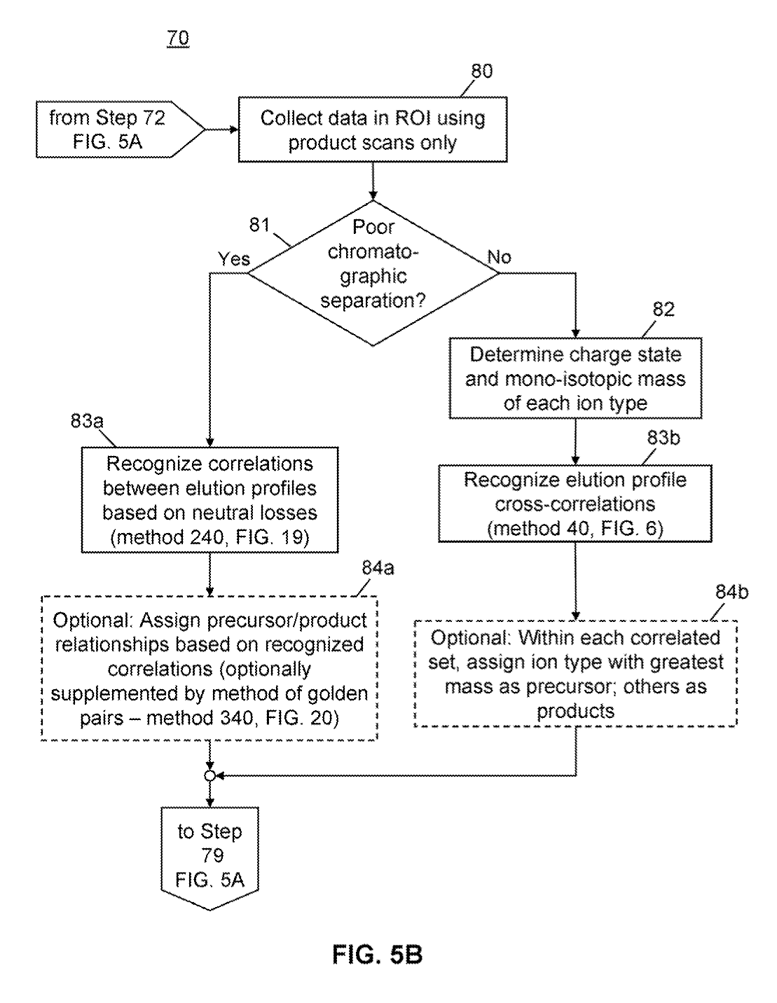

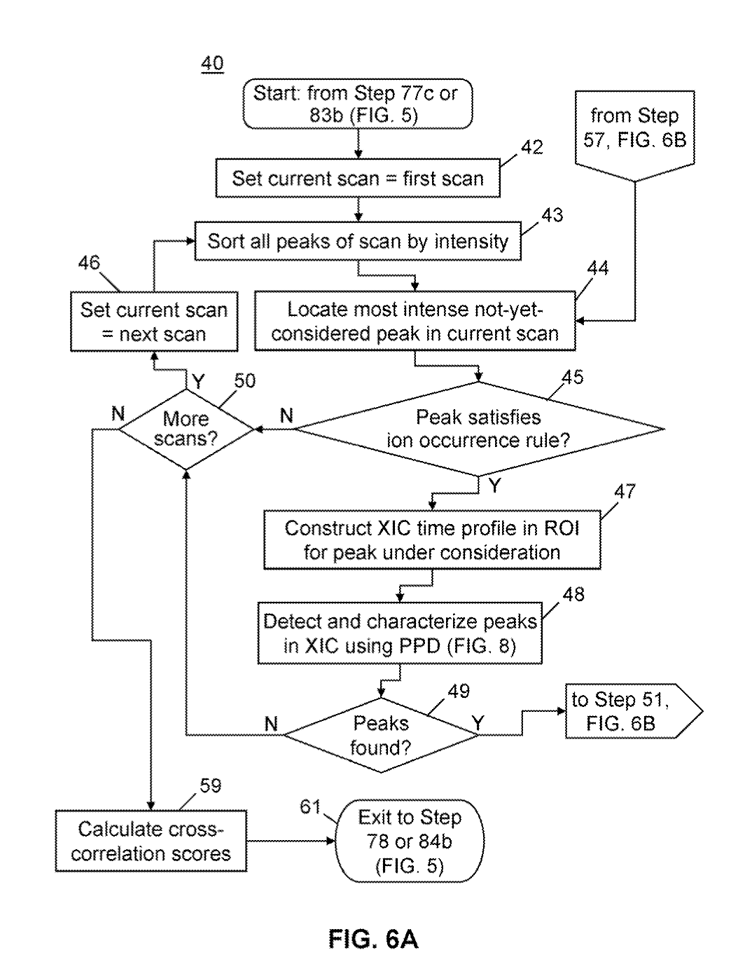

In accordance with the above considerations, FIGS. 5A-5B provide a high-level flow chart of a general method in accordance with the present teachings. In one aspect, the general method 70 illustrated in FIG. 5 may be considered as a method for acquiring data using a mass spectrometer system and interpreting that data, as it is acquired. According to this aspect, the method 70 corresponds to data acquisition and analysis within a certain region of interest (ROI) corresponding to a certain time window within which compounds elute from a chromatographs and are provided to a mass spectrometer. In another aspect, certain portions of the method 70 may be considered as a methods for processing stored mass spectrometry data after it is collected.

In step 71, the scan ratio, ρ(=n:m where n is a number of precursor-ion scans and m is a number of product-ion scans per unit time or within a certain time period) may optionally be set to an initial value, as described above. By way or example, without limitation, the number, n, of precursor-ion scans to be performed with regard to a certain ROI time window and/or the ratio, ρ, may be simply provided by a user or, alternatively, may be set to a certain default value. The default value, if any, may be specific to a certain region of interest depending upon, for example, the number of compounds expected to elute during the time window, the fragmentation efficiency of expected ions generated front the eluting, compounds or the anticipated widths of chromatogram peaks associated with the window. Note that, in general, it is frequently not necessary to perform as many precursor-ion scans as product ion scans. Accordingly, the scan ratio, ρ, will generally be less than unity. Optionally, the number, n, of precursor ion scans may not be held static but, instead, may be incremented (see step 74a during the course of data collection and analysis based on the observed mass spectra.

In step 72 of the method 70, if ρ>0, then at least one precursor ion scan will be performed and step 73 is performed next. However, if ρ=0, then no precursor ion scans will be performed (either in the experiment or in the portion of the experiment being considered as a region of interest) and step 80 (described below) is performed next. The scan ratio, ρ, may be set to zero, for instance, if it is confidently known that residual precursor ions will survive the fragmentation or reaction process and will this yield peaks that appear in the mass spectral data together with peaks relating to product ions.

At step 73, if the experimental conditions and precursor ion properties are such that complete fragmentation (no precursor ion survival) occurs, then data collection proceeds as in Step 74a. Otherwise, data collection proceeds as in step 74b. Step 74a specifies that during data collection within the region of interest (ROI), precursor-ion scans will be trigger triggered on a detected peak (such as a peak during detected during continuous measurements of total ion current). In contrast, step 74b specifies that data will be collected using the ratio ρ determined in step 71. The notation “n=n+1” shown in Step 74a in FIG. 5A indicates that the number of precursor ion scans to be performed during the ROI time window under consideration is incremented by 1.

Step 75 is executed after either of steps 74a, 74b. Step 75 determines if information regarding precursor-ion and product-ion mass-to-charge ratios and, possibly, retention times, has already been supplied. If so, then Step 77a is executed. This step comprises a mode of instrument operation and data analysis in which only the user-specified peaks are searched for during repetitive mass scanning. If ions with having peaks corresponding to the user-supplied mass-to-charge ratios are found to occur simultaneously, then the associated product and precursor ions are recognized as being correlated with one another.

If however, no user-supplied information is available (step 75), then the decision step, step 76 is executed. In step 76, an assessment is made regarding the quality of the chromatographic separation. The quality of the separation may be based, as but one non-limiting example, on the chromatographic resolution between peaks separated in time. This assessment may be made based on prior knowledge of the sample properties or chromatogram behavior or, possibly, based on data obtained earlier in the same experiment. Poor separation will lead to broad overlapping peaks which may degrade the accuracy of automatic peak detection by parameterless peak detection as described in Section 4 of this detailed description.

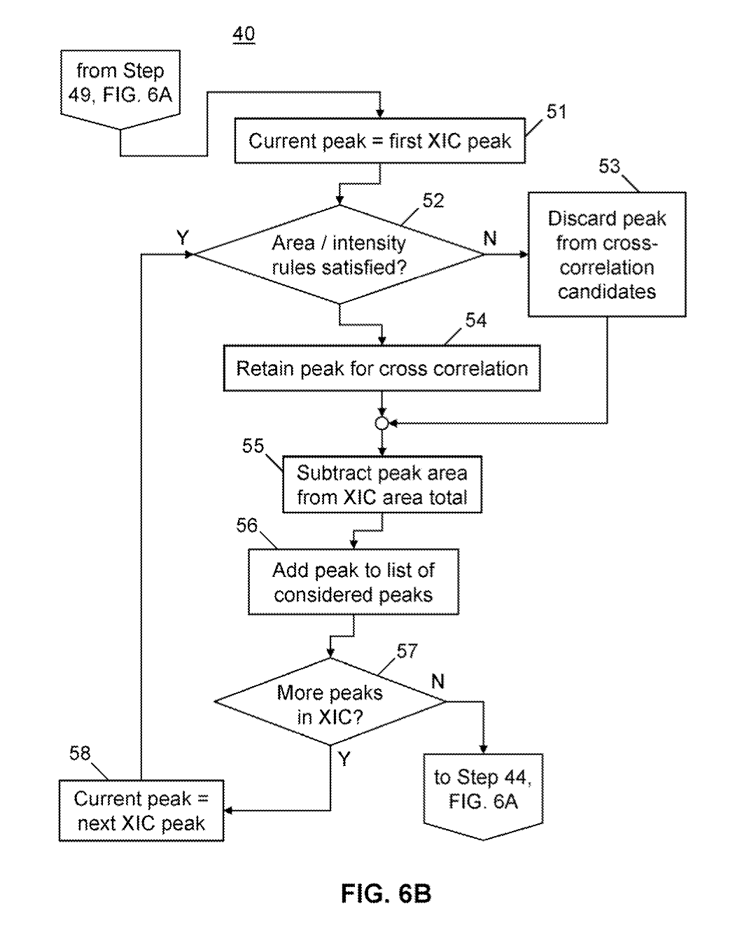

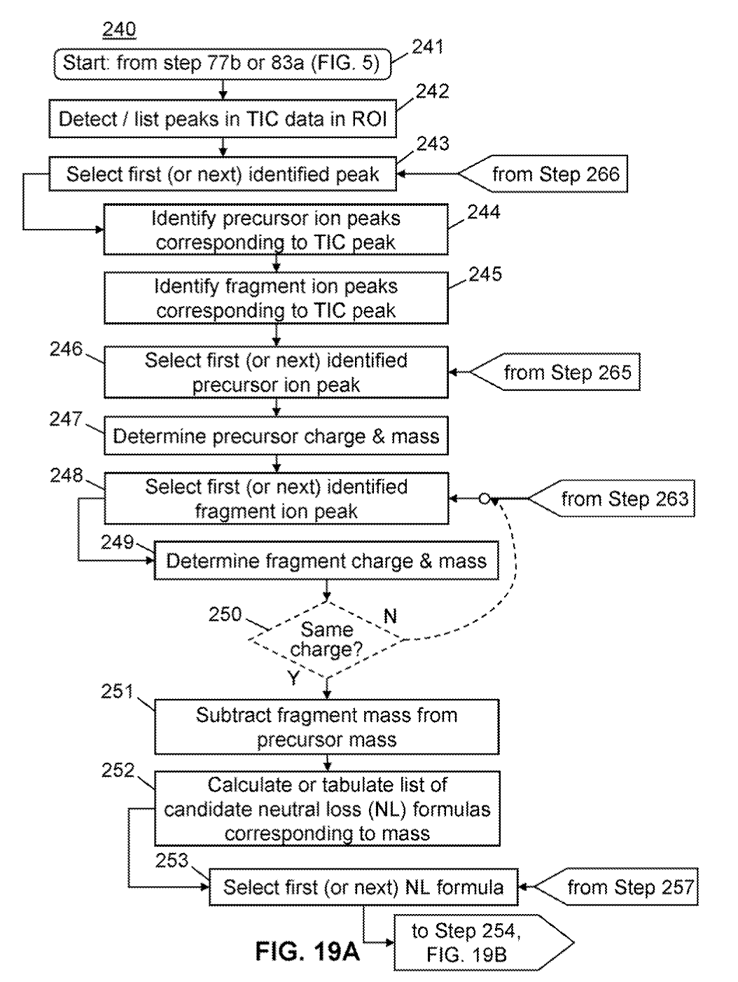

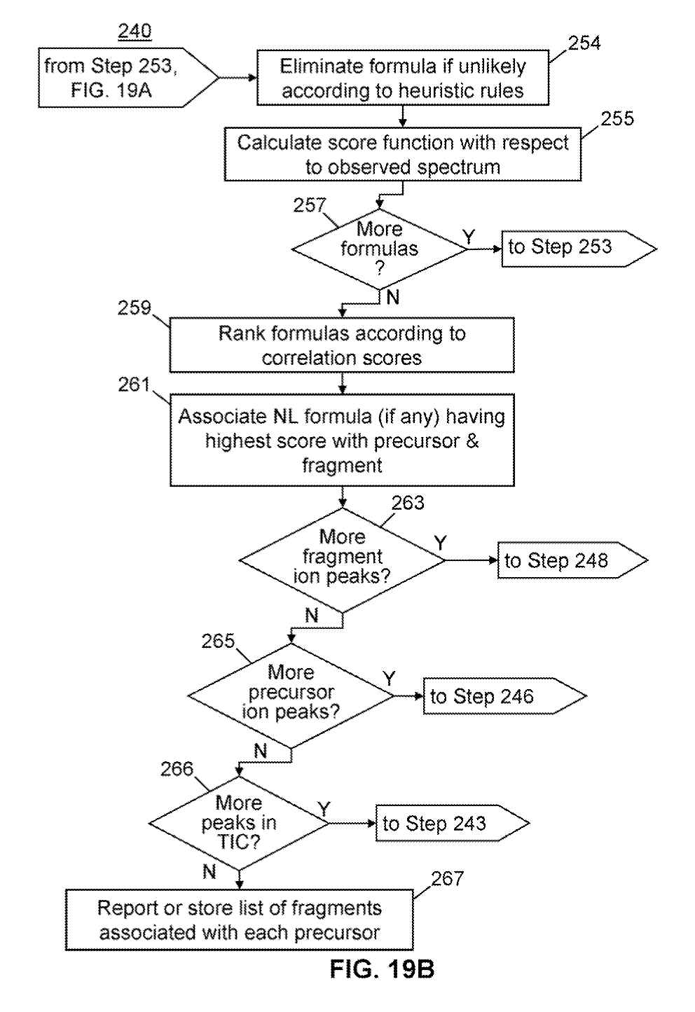

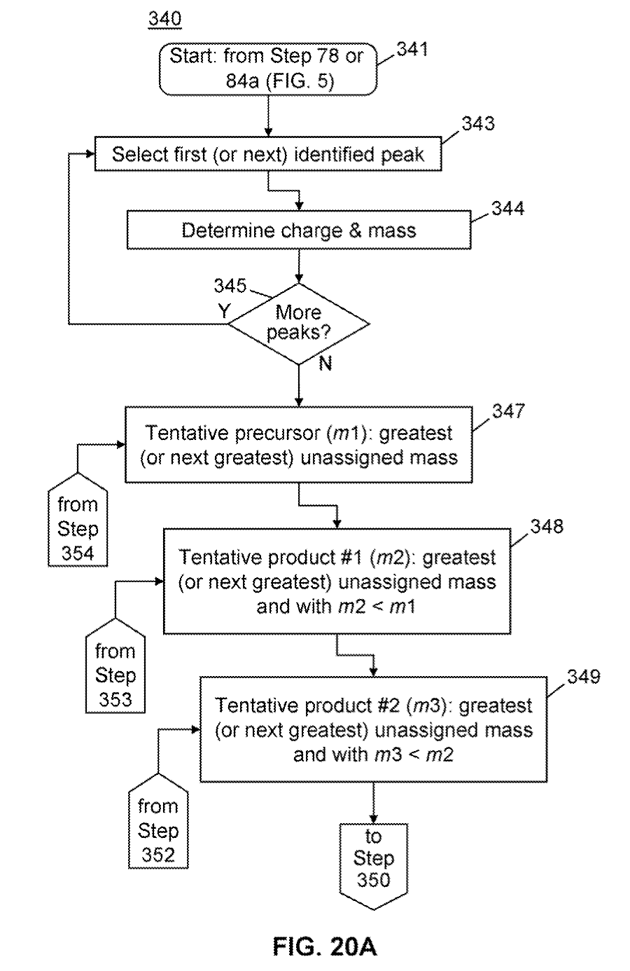

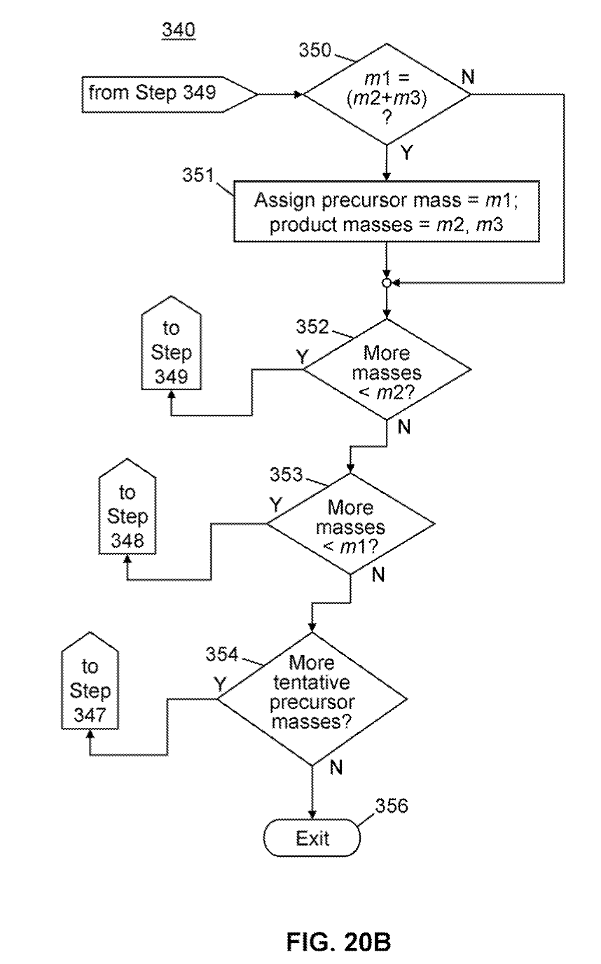

If the chromatographic separation (step 76) is not adequate, according to some pre-determined criterion such as if the chromatographic resolution is less than a certain threshold, then step 77b is executed. This step (77b) comprises a mode of instrument operation and data analysis in which correlations between precursor and product ions are based upon recognition of neutral losses that correspond to valid molecules. Such recognition of product/precursor correlations by recognition of neutral losses is described in Section 6 of this detailed description and is outlined in method 240 shown in FIG. 19. If the chromatographic separation (step 76) is judged to be, in fact, adequate (such as if the chromatographic resolution is greater than or equal to a certain threshold), then the step 77c is executed. This step (77c) comprises a mode of instrument operation and data analysis in which correlations between elution profiles are recognized by cross-correlation calculations of synthetic peak profiles generated by performing parameterless peak detection on extracted ion chromatograms. Generation of extracted ion chromatograms is described in Section 3 of this detailed description and is also outlined in method 40 shown in FIG. 6. The method of cross-correlation calculation is described in Section 5 of this detailed description. The method of parameterless peak detection as described in Section 4 of this detailed description. After execution of either step 77b or step 77e, then the optional step 78 may be performed, in which precursor/product relationships may be assigned based on the correlations in either of steps 77a, 77b, or 77c. These assignments may be verified or supplemented by performing the “method of golden pairs” as described in Section 7 of this description and as outlined in method 340 of FIG. 20.

Returning to step 72 of the method 70, if ρ=0, then no precursor ion scans will be performed because residual surviving precursor ions are expected to be recognizable in the all-ions fragmentation data. Accordingly, step 80 is performed in which the instrument is operated such that data is collected within the ROI using product-ion scans (all-ions fragmentation scans) only. The subsequent step 81 is similar to step 76, described above, and controls branching to either step 83a or step 82, based on chromatographic resolution. Step 83a, is similar to already-described step 77b and comprises a mode of instrument operation and data analysis in which correlations between precursor and product ions are based upon recognition of neutral losses that correspond to valid molecules. The optional subsequent step 84a is similar to the already-described step 78 and comprises optionally assigning precursor/product relationships based on the correlations recognized in step 83a, possibly supplemented by the “method of golden pairs”.

If, in the decision step, step 81, the chromatographic separation is judged to be adequate, then step 82 is next executed, in which the charge state and monoisotopic mass of each ion type (i.e., each peak) is determined. These quantities can usually be determined from the pattern of lines in the mass spectrum corresponding to a natural isotopic distribution. Then, in step 83b elution profile correlations are recognized by cross-correlation calculations (Section 5 of this detailed description and method 40 of FIG. 6) using only the data from the all-ions fragmentation scans including product ions and residual precursor ions. In the optional subsequent step 84h, ion types may be assigned within each set of ions whose elution profiles are determined to be correlated. Specifically, if this step is performed, the ion type (i.e., peak) with the greatest (monoisotopic) mass is assigned as the precursor; other ion types are assigned as products.

Finally, the method 70 terminates in Step 79, in which results are reported or stored. The results may include calculated product/precursor matches, information regarding detected peaks or other information. In the absence of product/precursor assignments, simple lists of correlated ions may be reported or stored. If fragmentation or reaction of precursors is complete, such that no discernible precursor ions survive fragmentation, each reported or stored list will include only fragment or product ions. Such lists of correlated fragment or product ions may, by way of non-limiting example, be sufficient for detection or identification of molecular species from which the ions were generated. The reporting may be performed in numerous alternative ways—for instance via a visual display terminal, a paper printout, or, indirectly, by outputting the parameter information to a database on a storage medium for later retrieval by a user. The reporting, step may include reporting either textual or graphical information, or both. Reported peak parameters may be either those parameters calculated during the peak detection step or quantities calculated from those parameters and may include, for each of one or more peaks, location of peak centroid, location of point of maximum intensity, peak half-width, peak skew, peak maximum intensity, area under the peak, etc. Other parameters related to signal to noise ratio, statistical confidence in the results, goodness of fit, etc may also be reported in step 79.

### Section 3. Generation of Extracted Ion Chromatograms

FIGS. 6A-6B present a flowchart of a method 40 for performing either the step 77c or 83b (of method 70 shown in FIG. 5) so as to automatically recognize correlations between elution profiles of ions. The method 40 diagramed in FIG. 6 is but one example of such a method that may be employed. At a high- or most-general level, the method 40 may be replaced any algorithm that systematically examines the data searching for peaks to be tested by subsequent cross-correlation calculation. The calculations of method 40 may be performed on mass spectral data relating to a current region of interest (ROI)—that is, a certain time range—of recently collected data as noted above. In embodiments, the time increment corresponding to the ROI is 0.6 minutes wide, but other window widths will work equally well as long as the window width is greater than the expected peak width. These time windows represent a small portion of a typical chromatographic experiment which may run for several tens of minutes to on the order of an hour. For data dependent instrument control, a much smaller time window would probably be used. Such data dependent instrument control functions may be performed in automated fashion, wherein the results obtained by the methods herein are used to automatically control operation of the instrument at a subsequent time during the same experiment from which the data were collected. For instance, based on the results of the algorithms, a voltage may be automatically adjusted in an ion source or an acceleration potential may be adjusted with regard to in-source fragmentation operation. Such automatic instrument adjustments may be performed, for instance, so as to optimize the type or number of ions or ion fragments produced.

In step 42 of the present example (FIG. 6A), the scan to be examined (the current scan) is set to be the initial scan within the ROI. This is an initialization step for a loop in which scans are sequentially examined. In step 43, the peaks of the current scan are sorted by intensity and the ions are examined one by one, starting with the most intense (step 44). In general, all ions are examined, but for very rapid work or strong signals, a threshold may be applied and only ions with intensities above threshold examined. In the present example, step 59 (described in greater detail later in this document) is performed when all ions in all scans of the ROI have been examined. In step 45 of this example, the occurrence of an ion is noted, and its history or time-profile is compared to a rule for ions to be considered as forming a peak. A preferred rule that is used is that the ion must occur in three contiguous scans (scans of the same type), but any rule based on ion appearance and scan number may be used. For example, a rule that the ion must appear in 3 of 5 contiguous scans might alternatively be chosen, (ions are considered identical if they agree within the mass tolerance, and as an ion history is accumulated, any new occurrence is compared to the average value of the previous instances, not simply the previous instance.)

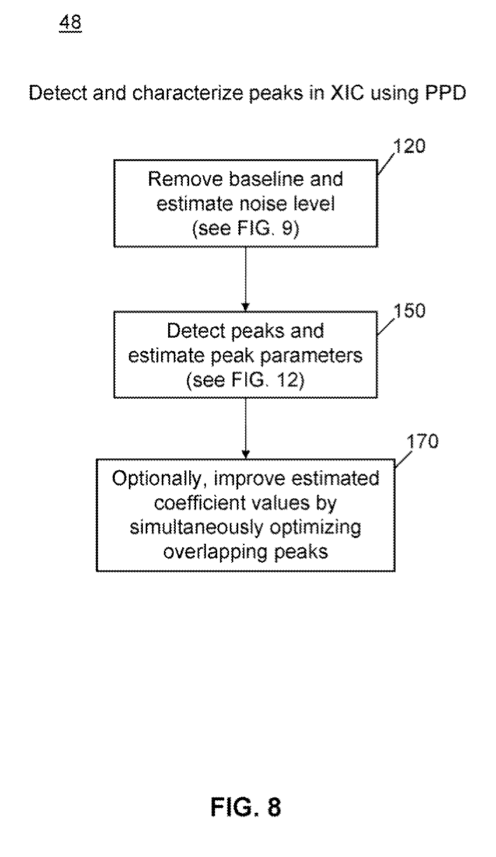

If, in step 45, the peak does not satisfy the ion occurrence rule, then, if there are more unexamined scans in the ROI (determined in step 50), the current scan is set to be the next unexamined scan (step 46) and the method returns to step 43 to begin examining the new current scan. If the ion occurrence rule (as determined in step 45) is satisfied, then an extracted ion chromatogram corresponding to the m/z range of the ion peak under consideration is constructed in step 47. It is to be noted that the terms “mass” and “mass-to-charge” ratio, as used here, actually represent a small finite range of mass-to-charge ratios. The width or “window” of the mass-to-charge range is the stated precision of the mass spectrometer instrument. The technique of Parameterless Peak Detection (PPD, see FIG. 8 and discussion thereof as well as U.S. Pat. No. 7,983,852) then attempts to find peaks in an extracted ion chromatogram (XIC) corresponding, to a time window (for example, a time window that is 0.6 minutes in duration) in step 48. Once this particular mass has been tested for peaks in the XIC, it is not tested again until the center of the time window has increased by the window size, (So, for example, if an ion is tested for peaks when the time window is 2.0-2.6, it will not be tested again until the window is 2.6-3.2.)

Subsequent steps of the method 40 are performed using the analytical functions provided by the synthetic fitted peaks generated by PPD (or calculated peak parameters) instead of using the original data. If, in the decision step 49, no peaks are found by PPD for the mass under consideration, then, if there are remaining unexamined scans (step 50), the method returns back to step 46 and then step 43. However, if peaks are found, then the method continues to step 51 (FIG. 6B) in which the first of possibly several peaks in the XIC is set for initial consideration. In the next step 52, for each peak found by PPD, additional rules of large relative area and high relative intensity (described in further detail in the next paragraph) are applied. Peaks that fail these tests are discarded (step 53), whereas those that pass are accepted and retained (step 54) for further processing by cross-correlation score calculations (such correlation scores are calculated in step 59). Regardless of whether or not a peak is accepted, after each peak is considered, the peak area of the peak is subtracted (step 55) from the total area used in the relative area criterion in subsequent iterations of step 52. Also (step 56) the peak is added to a list of peaks within the ROI that have been examined, to prevent possible duplicate consideration of a single peak.

The step 52 of the method 40 is now discussed in more detail. In step 52, the area of, Aᵢ, of the peak currently under consideration (the j^{th} peak) is noted. Also, the total area (ΣA) under the curve the fitted chromatogram and the average peak height (Jₐᵥₑ) of any remaining peaks in the fitted chromatogram are calculated. The area ΣA is the area of the data remaining after any previous peaks have been detected and removed. The step 52 compares the area, Aⱼ, of the most recently found peak to the total area (ΣA). Also, this step compares the peak maximum intensity, Iⱼ, of the most recently found peak is compared to Iₐᵥₑ. If it is found either that (Aⱼ/ΣA)<ω or that (Iⱼ/Iₐᵥₑ)<ρ, where ω and ρ are pre-determined constants, then the execution of the method 40 branches to step 53 in which the peak is removed from a list of peaks to be considered in—and is thus eliminated from consideration in—the subsequent cross correlation score calculation step.

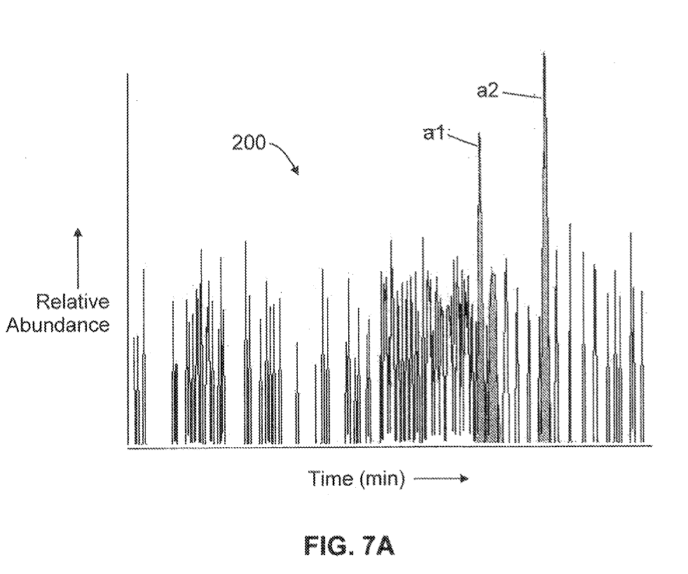

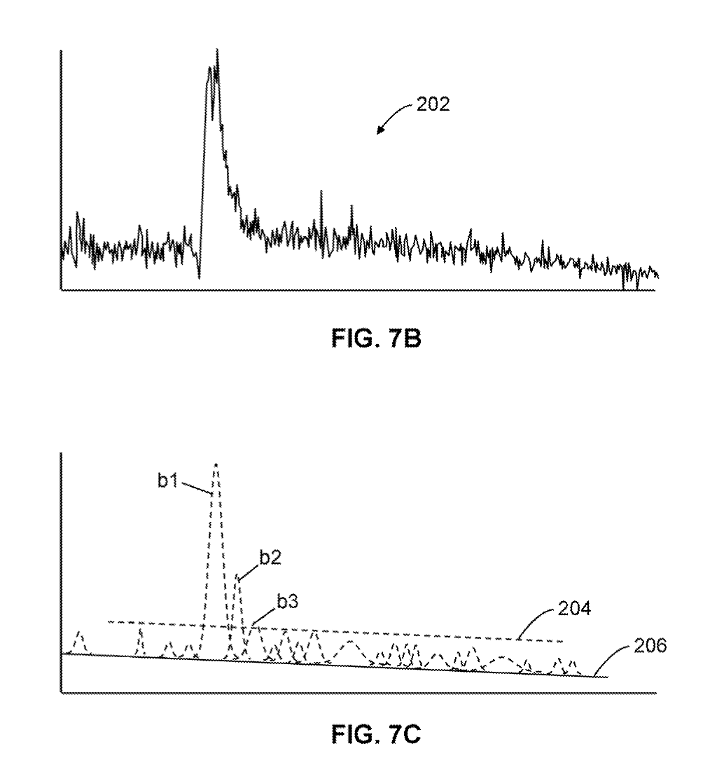

The removal of certain peaks in this fashion renders the fitted peak set consistent with the expectations that, within an XIC, each actual peak of interest should comprise a significant peak area, relative to the total peak area and should comprise a vertex intensity that is significantly greater than the local average intensity. FIGS. 7A-7C schematically illustrate this concept. For instance, after peak discrimination in step 52 (FIG. 6B), fitted peaks corresponding to data peaks a1 and a2 in of the XIC 200 in FIG. 7A may, in some embodiments, not be retained in the list of peaks to be tested by cross correlation as a result of their relatively smaller peak areas in relation to the total area above the baseline. In various embodiments, the retention of peaks may be determined based on statistical considerations—such as correlation statistics between different data files—or possibly some other criteria related to relative peak areas. Numerous fitted peaks in FIG. 7C, which represent a fit to the XIC 202 of FIG. 7B, are eliminated by a different criterion. For example, all fitted peaks in FIG. 7C that do not extend above line 204 may be eliminated because their peak heights do not meet a peak height criterion, even though the areas of several of them are not insignificant. In the illustrated example, line 206 is a baseline and line 204 is a line offset from the baseline such that the vertical distance between the two lines represents a minimum peak height for acceptance. Thus, in this case, only peaks b1, b2 and b3 are retained. In various embodiments, the retention of peaks may be determined based on statistical considerations or some other criteria related to relative peak heights.

Returning to the discussion of the method 40 (FIG. 6B), it may be noted that if the decision step 57 determines that more peaks exist in the XIC under consideration, then the method branches to step 58 in which the next peak is set for consideration and then back to step 52. If however, it is determined that no additional peaks remain the XIC, then execution goes back to step 44 (FIG. 6A) so as to continue examining additional peaks (if any) in the current scan. The above-described sequence continues until all peaks in all scans have been examined and, consequently, all peaks to be used for matching have been identified. Subsequently, in step 59, the cross correlation for each retained XIC peak is calculated with respect to every other mass that formed an XIC peak in the region of interest time range. Each detected peak is considered, through a cross-correlation calculation, against every other detected peak in order to match ion types and to recognize relationships between ion types having similar elution profiles. The details of the calculations are presented in a subsequent section herein. The method 40 terminates at step 61.

### Section 4. Parameterless Peak Detection in One Independent Variable

The method 40 diagrammed in FIGS. 6A-6B provides a high-level overview of generating automated correlations between the elution profiles of the various ion types. However, to fully understand and appreciate the features of the invention, it is necessary to significantly more detailed discussion of the step 48 of method 40 as well as additional procedures subsumed therein. The step 48 includes detecting and locating peaks in various extracted-ion-chromatogram (XIC) representations of the mass spectral data and may itself be regarded as a particular method, which is shown in flowchart form in FIG. 8. Since each XIC includes only the single independent variable of time (e.g., Retention Time), this section is thus directed to detection of peaks in data that includes only one independent variable. Much of the discussion in the present section is adapted from the discussion in the aforementioned U.S. Pat. No. 7,983,852.

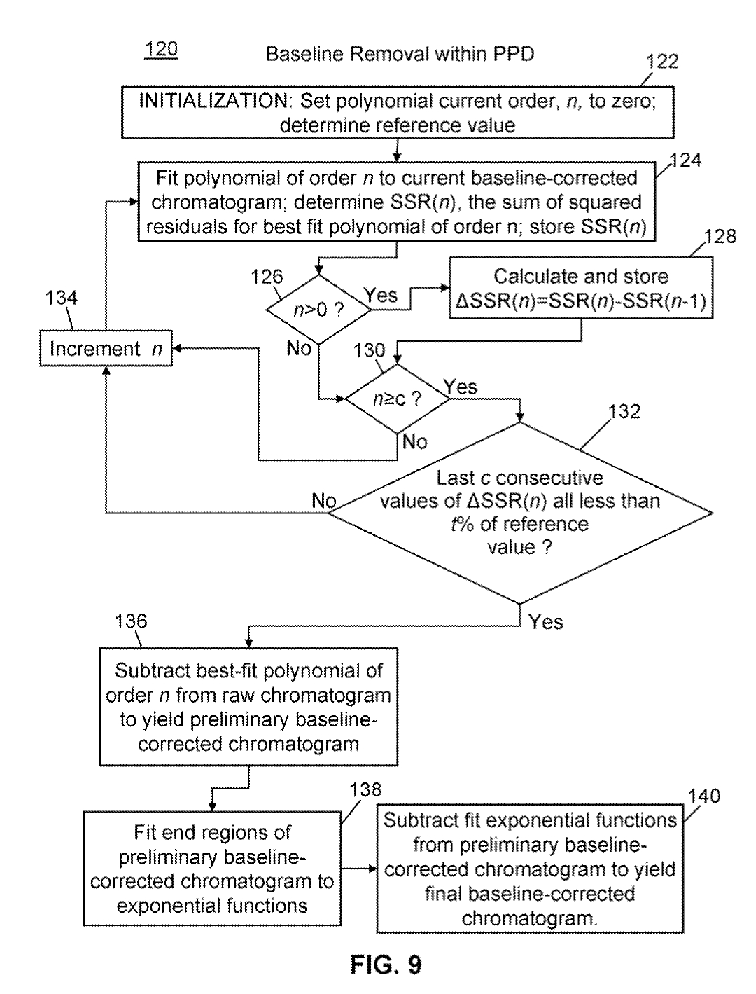

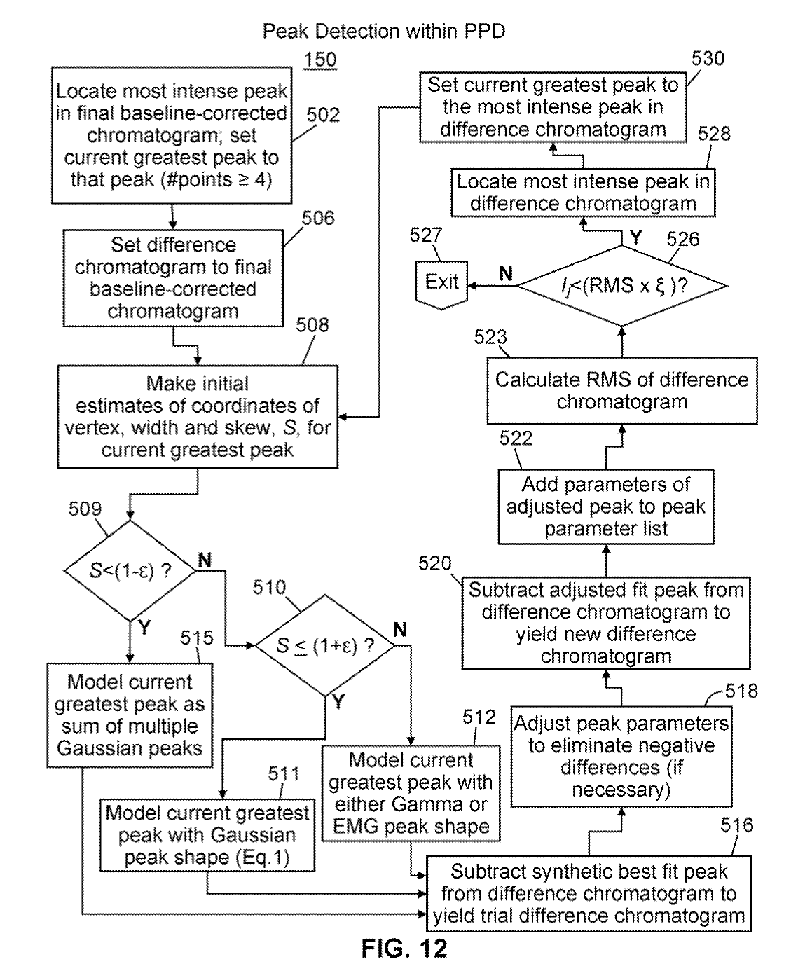

The various sub-procedures or sub-methods in the method 48 may be grouped into three basic stages of data processing, each stage possibly comprising several steps as illustrated in FIG. 8. The first step, step 120, of the method 48 is a preprocessing stage in which baseline features may be removed from the received chromatogram and in which a level of random “noise” of the chromatogram may be estimated, this step being described in greater detail in subsequent FIG. 9. The next step 150, which is described in greater detail in FIG. 12, is the generation of an initial estimate of the parameters of synthetic peaks, each of which models a positive spectral feature of the baseline corrected chromatogram. Such parameters may relate, for instance, to peak center, width, skew and area of modeled peaks, either in preliminary or intermediate form. The subsequent optional step 170 includes refinement of fit parameters of synthetic peaks determined in the preceding step 150 in order to improve the fit of the peaks, taken as a set, to the baseline corrected chromatogram. The need for such refinement may depend on the degree of complexity or accuracy employed in the execution of modeling in step 150.

The term “model” and its derivatives, as used herein, may refer to either statistically finding a best fit synthetic peak or, alternatively, to calculating a synthetic peak that exactly passes through a limited number of given points. The term “fit” and its derivatives refer to statistical fitting so as to find a best-fit (possibly within certain restrictions) synthetic peak such as is commonly done by least squares analysis. Note that the method of least squares (minimizing the chi-squared metric) is the maximum likelihood solution for additive white Gaussian noise. More detailed discussion of individual method steps and alternative methods is provided in the following discussion and associated figures.

### 4.1. Baseline Detection

A feature of a first stage of the method 48 (FIG. 8) takes note of the concept that (disregarding, for the moment, any chemical or electronic noise) a spectroscopic signal generally consists of signal plus baseline. If one can subtract the baseline correctly, everything that remains must be signal, and should be fitted to some sort of data peak. Thus, the first step 120 comprises determining a correct baseline and removing it from the signal. Sub-steps may include applying a polynomial curve as the baseline curve, and measuring the residual (the difference between the chromatographic data and the computed baseline) as a function of polynomial order. For instance, FIG. 9 illustrates a flowchart of a method 120 for automatically removing baseline features from spectral data in accordance with some possible implementations. The method 120 illustrated in FIG. 9 repeatedly fits a polynomial function to the baseline, subtracts the best fit polynomial function from the chromatogram so as to provide a current baseline-corrected chromatogram, evaluates the quality of the fit, as measured by a sum of squared residuals (SSR), and proceeds until SSR changes, from iteration to iteration, by less than some pre-defined percentage of its original value for a pre-defined number of iterations.

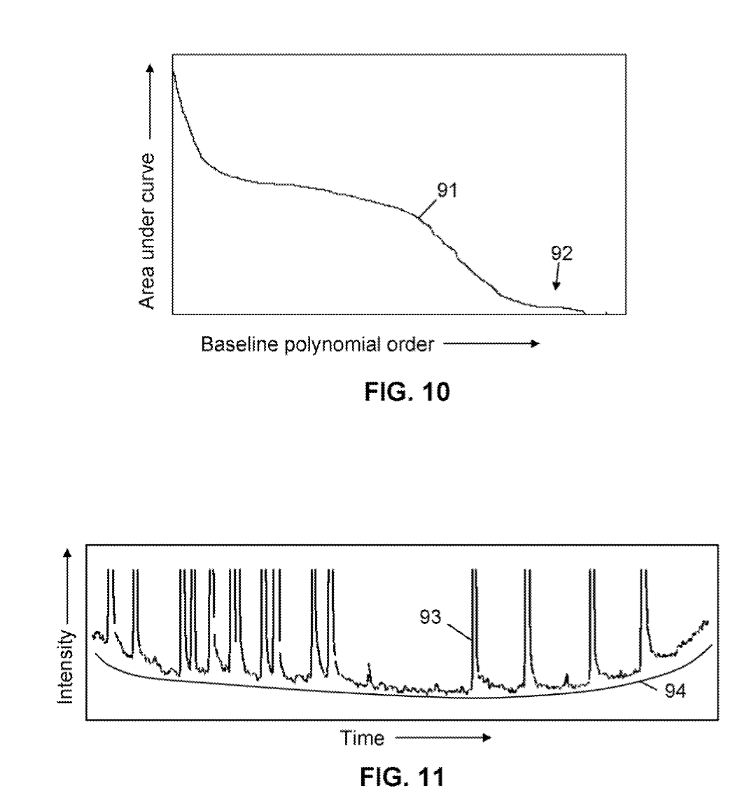

FIG. 10 is an exemplary graph 91 of the variation of the calculated area underneath a baseline-corrected spectral curve as a function of increasing order of the polynomial used in fitting the baseline. FIG. 10 shows that the area initially decreases rapidly as the order of the best fit polynomial increases. This function will go from some positive value at order zero, to a value of zero at some high polynomial order. However, as may be observed from FIG. 10, after most of the baseline curvature has been fit, the area function attains a plateau region 92 for which the change in the function between polynomial orders is some relatively small amount (for instance 5% of its initial value). At this point, the polynomial-fitting portion of the baseline determination routine may be terminated.

To locate the plateau region 92 as indicated in FIG. 10, methods according to various implementations may repeatedly compute the sum of squared residuals (SSR) for sequential values of polynomial order, each time computing the difference of the SSR (ΔSSR) determined between consecutive polynomial orders. This process is continued until a region is found in which the change (ΔSSR) is less than the pre-defined percentage (for instance, 5%) of a certain reference value determined from the chromatogram for a certain number c (for instance, four) of sequential iterations. The reference value may comprise, for instance, the maximum intensity of the original raw chromatogram. Alternatively, the reference value may comprise the sum of squared values (SSV₀) of the original raw chromatogram or some other quantity calculated from the spectral values.

Once it is found that ΔSSR less than the pre-defined percentage of the reference value for c iterations, then one of the most recent polynomial orders (for instance, the lowest order of the previous four) is chosen as the correct polynomial order. The subtraction of the polynomial with the chosen order yields a preliminary baseline corrected chromatogram, which may perhaps be subsequently finalized by subtracting exponential functions that are fit to the end regions. Although the above discussion regarding baseline removal is directed to the general case, it should be noted that the mere construction of an XIC representation eliminates signal from most interfering ions. Thus, the magnitudes of baseline offset and baseline curvature are generally minimal for such data representations.

Returning, now, to the discussion of method 120 shown in FIG. 9, it is noted that the first step 122 comprises loop initialization step of setting the order, ii, of the baseline fitting polynomial to an initial value of zero and determining a reference value to be used, in a later step 132, for determining when the fitting polynomial provides an adequate fit to the baseline. The reference value may simply be the maximum intensity of the raw chromatogram. Alternatively, the reference value may be some other measure determined from the chromatogram, such as the sum of the squared values (SSV) of the chromatogram.

From step 122, the method 120 proceeds to a step 124, which is the first step in a loop. The step 124 comprises fitting a polynomial of the current order (that is, determining the best fit polynomial of the current order) to the raw chromatogram by the well-known technique of minimization of a sum of squared residuals (SSR). The SSR as a function of n, SSR(n) is stored at each iteration for comparison with the results of other iterations.

From step 124, the method 120 proceeds to a decision step 126 in which, if the current polynomial order n is greater than zero, then execution of the method is directed to step 128 in order to calculate and store the difference of SSR, ΔSSR(n), relative to its value in the iteration just prior. In other words, ΔSSR(n)=SSR(n)−SSR(n−1). The value of ΔSSR(n) may be taken a measure of the improvement in baseline fit as the order of the baseline fitting polynomial is incremented to n.

The iterative loop defined by all steps from step 124 through step 132, inclusive, proceeds until SSR changes, from iteration to iteration, by less than some pre-defined percentage, t %, of the reference value for a pre-defined integer number, c, of consecutive iterations. Thus, the number of completed iterations, integer n, is compared to c in step 130. If n≧c, then the method branches to step 132, in which the taste values of ΔSSR(n) are compared to the reference value. However, in the alternative situation (n<c), there are necessarily fewer than c recorded values of ΔSSR(n), and step 132 is bypassed, with execution being directed to step 134, in which the integer n is incremented by one.

The sequence of steps from step 124 up to step 132 (going through step 128, as appropriate) is repeated until it is determined, in step 132, that the there have been c consecutive iterations in which the SSR value has changed by less than t % of the reference value. At this point, the polynomial portion of baseline correction is completed and the method branches to step 136, in which the final polynomial order is set and a polynomial of such order is subtracted from the raw chromatogram to yield a preliminary baseline-corrected chromatogram.

The polynomial baseline correction is referred to as “preliminary” since, in a general case, edge effects may cause the polynomial baseline fit to be inadequate at the ends of the data, even though the central region of the data may be well fit. FIG. 11 shows an example of such a preliminary baseline corrected chromatogram 93. The residual baseline curvature within the end regions (for instance, the leftmost and rightmost 20% of the chromatogram) of the chromatogram 93 are well fit by a sum of exponential functions (one for each end region), the sum of which is shown in FIG. 11 as curve 94. Either a normal or an inverted (negated) exponential function may be employed, depending on whether the data deviates from zero in the positive or negative direction. This correction may be attempted at one or both ends of the chromatogram. Thus, the method 120 proceeds to step 138 which comprises least squares fitting of the end region baselines to exponential functions, and then to step 140 which comprises subtraction of these functions from the preliminary baseline-corrected chromatogram to yield the final baseline corrected chromatogram. These steps yield a final baseline-corrected chromatogram. Although this discussion regarding baseline edge-effect curvature is directed to the general case, it should be noted that the mere construction of an XIC representation eliminates signal from most interfering ions. Thus, the magnitude of baseline curvature is generally minimal for such data representations.

### 4.2. Peak Detection

At this point, after the application of the steps outlined above, the baseline is fully removed from the data and the features that remain within the chromatogram above the noise level may be assumed to be analyte signals. The methods described in FIG. 12 locate the most intense region of the data, tit it to one of several peak shapes, remove that theoretical peak shape from the experimental data, and then continue to repeat this process until there are no remaining data peaks with a signal-to-noise ratio (SNR) greater than some pre-determined value, s, greater than or equal to unity. The steps of this process are illustrated in detail in FIG. 12 as method 150 and also shown in FIG. 8 as step 150. The pre-defined value, s, may be chosen so as to limit the number of false positive peaks. For instance, if the RMS level of Rayleigh-distributed noise is sigma, then a peak detection threshold, s, of 3 sigma leads to a false detection rate of about 1%.

The method 150, as shown in FIG. 12 is an iterative process comprising initialization steps 502 and 506 and loop steps 508-530 (including loop exit decision step 526) and termination step 527. A new respective peak is located and modeled during each iteration of the loop defined by the sequence of steps 508-530.

The first step 502 of method 150 comprises locating the most intense peak in the final baseline-corrected chromatogram and setting, a program variable, current greatest peak, to the peak so located. It is to be kept in mind that, as used in this discussion, the acts of locating a peak or chromatogram, setting or defining a peak or chromatogram, performing algebraic operations on a peak or chromatogram, etc implicitly involve either point-wise operations on sets of data points or involve operations on functional representations of sets of data points. Thus, for instance, the operation of locating the most intense peak in step 502 involves locating all points in the vicinity of the most intense point that are above a presumed noise level, under the proviso that the total number of points defining a peak must be greater than or equal to four. Also, the operation of “setting” a program variable, current greatest peak, comprises storing the data of the most intense peak as an array of data points.

From step 502, the method 150 proceeds to second initialization step 506 in which another program variable, “difference chromatogram” is set to be equal to the final baseline-corrected chromatogram (see step 140 of method 120. FIG. 9). The difference chromatogram is a program variable that is updated during each iteration of the loop steps in method 150 so as to keep track of the chromatogram resulting from subtraction of all prior-fitted peaks from the final baseline-corrected chromatogram. As discussed later in this document, the difference chromatogram is used to determine when the loop is exited under the assumption that, once all peaks have been located and modeled, the difference chromatogram will consist only of “noise”.

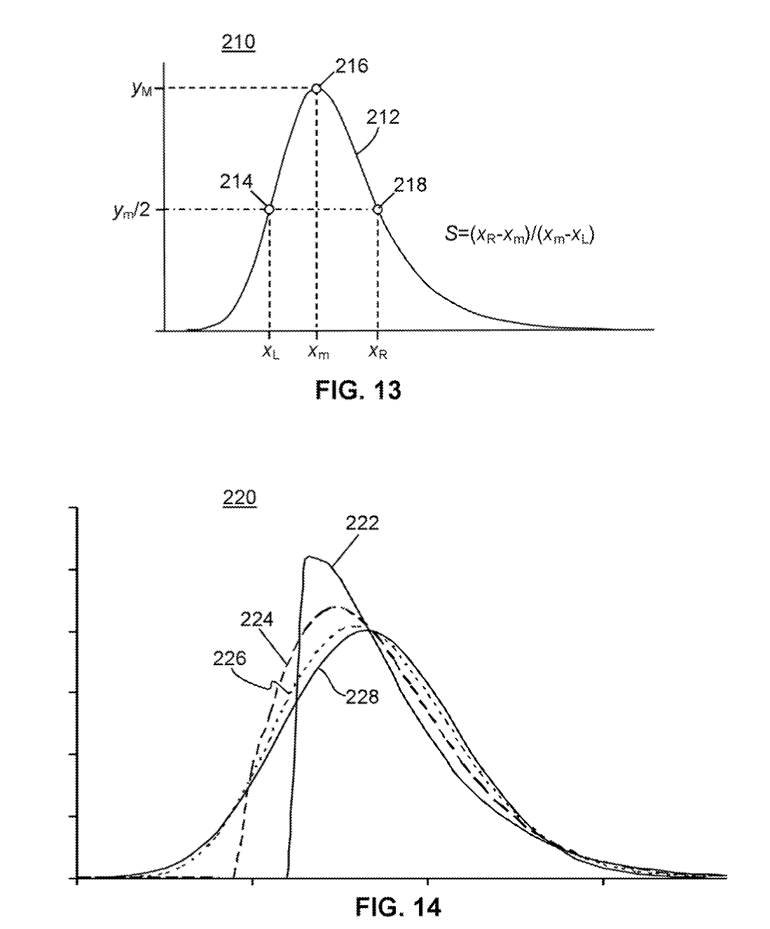

Subsequently, the method 150 enters a loop at step 508, in which initial estimates are made of the coordinates of the peak maximum point and of the left and right half-height points for the current greatest peak and in which peak skew, S is calculated. One method of estimating these co-ordinates is schematically illustrated as graph 210 in FIG. 13. Letting curve 212 of FIG. 13 represent the current greatest peak, then the co-ordinates of the peak maximum point 216, left half-height point 214 and right half-height point 218 are, respectively, (xₘ, yₘ), (x_{L}, yₘ/2) and (x_{R}, yₘ/2). The peak skew, S, is then defined as: S=(x_{R}−xₘ)/(xₘ−x_{L}).

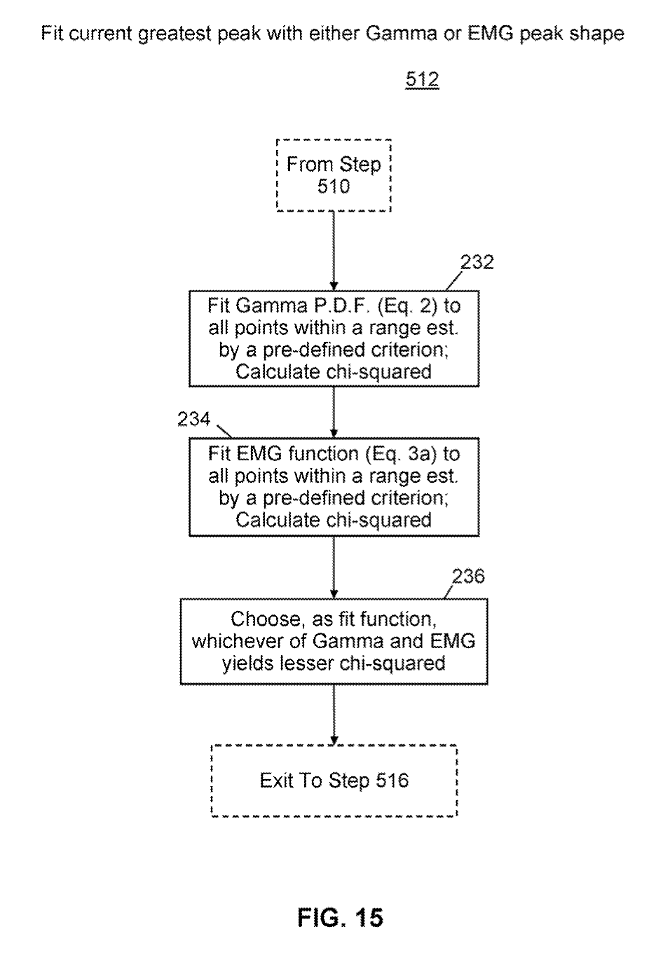

In steps 509 and 510, the peak skew, S, may be used to determine a particular form (or shape) of synthetic curve (in particular, a distribution function) that will be subsequently used to model the current greatest peak. Thus, in step 509, if S<(1−ε), where ε is some pre-defined positive number, such as, for instance, ε=0.05, then the method 150 branches to step 515 in which the current greatest peak is modeled as a sum of two or more Gaussian distribution functions (in other words, two Gaussian peaks). Otherwise, in step 510, if S≦(1+ε), then the method 150 branches to step 511 in which a (single) Gaussian distribution function is used as the model peak form with regard to the current greatest peak. Otherwise, the method 150 branches to step 512, in which either a gamma distribution function or an exponentially modified Gaussian (EMG) or some other form of distribution function is used as the model peak form. Alternatively, the current greatest peak could be modeled as a sum of two or more Gaussian distribution functions in step 512. A non-linear optimization method such as the Marquardt-Levenberg Algorithm (MLA) or, alternatively, the Newton-Raphson algorithm may be used to determine the best fit using any particular peak shape. After either step 511, step 512 or step 515, the synthetic peak resulting from the modeling of the current greatest peak is removed from the chromatogram data (that is, subtracted from the current version of the “difference chromatogram”) so as to yield a “trial difference chromatogram” in step 516. Additional details of the gamma and EMG distribution functions and a method of choosing between them are discussed in greater detail, partially with reference to FIG. 15, later in this document.

Occasionally, the synthetic curve representing the statistical overall best-fit to a given spectral peak will lie above the actual peak data within certain regions of the peak. Subtraction of the synthetic best fit curve from the data will then necessarily introduce a “negative” peak artifact into the difference chromatogram at those regions. Such artifacts result purely from the statistical nature of the fitting process and, once introduced into the difference chromatogram, can never be subtracted by removing further positive peaks. However, physical constraints generally require that all peaks should be positive features. Therefore, an optional adjustment step is provided as step 518 in which the synthetic peak parameters are adjusted so as to minimize or eliminate such artifacts.

In step 518 (FIG. 12), the solution space may be explored for other fitted peaks that have comparable squared differences but result in residual positive data. A solution of this type is selected over a solution that gives negative residual data. Specifically, the solution space may be incrementally walked so as to systematically adjust and constrain the width of the synthetic peak at each of a set of values between 50% and 150% of the width determined in the original unconstrained least squares fit. After each such incremental change in width, the width is constrained at the new value and a new least squared fit is executed under the width constraint. The positive residual (the average difference between the current difference chromatogram and the synthetic peak function) and chi-squared are calculated and temporarily stored during or after each such constrained fit. As long as chi-squared doesn't grow beyond a certain multiple of its initial value, for instance 3-times its initial value, the search continues until the positive residual decreases to below a certain limit, or until the limit of peak width variation is reached. This procedure results in an adjusted synthetic fit peak which, in step 520, is subtracted from the prior version of the difference chromatogram so as to yield a new version of the difference chromatogram (essentially, with the peak removed). In step 522, information about the most recently adjusted synthetic peak, such as parameters related to peak form, center, width, shape, skew, height and/or area are stored.

In step 523, the root-of-the-mean squared values (root-mean-square or RMS) of the difference chromatogram is calculated. The ratio of this RMS value to the intensity of the most recently synthesized peak may be taken as a measure of the signal-to-noise (SNR) ratio of any possibly remaining peaks. As peaks continue to be removed that is, as synthetic fit peaks are subtracted in each iteration of the loop), the RMS value of the difference chromatogram approaches the RMS value of the noise.

Step 526 is entered from step 523. In step 526, as each tentative peak is found, its maximum intensity, I, is compared to the current RMS value, and if I<(RMS×ξ) where ξ is a certain pre-defined noise threshold value, greater than or equal to unity, then further peak detection is terminated. Thus, the loop termination decision step 526 utilizes such a comparison to determine if any peaks of significant intensity remain distinguishable above the system noise. If there are no remaining significant peaks present in the difference chromatogram, then the method 150 branches to the final termination step 527. However, if data peaks are still present in the residual chromatogram, the calculated RMS value will be larger than is appropriate for random noise and at least one more peak must be fitted and removed from the residual chromatogram, in this situation, the method 150 branches to step 528 in which the most intense peak in the current difference chromatogram is located and then to step 530 in which the program variable, current greatest peak, is set to the most intense peak located in step 528. The method then loops back to step 508, as indicated in FIG. 12.

Methods as described herein (e.g., method 150) may employ a library of peak shapes containing at least four curves (and possibly others) to model observed peaks: a Gaussian for peaks that are nearly symmetric; a sum of two Gaussians for peaks that have a leading edge (negative skewness); a and either an exponentially modified Gaussian or a Gamma distribution function for peaks that have a tailing edge (positive skewness). The modeling of spectral peaks with Gaussian peak shapes is well known and will not be described in great detail here. In brief, a Gaussian functional form may be employed that utilizes exactly three parameters for its complete description, these parameters usually being taken as area A, mean μ and variance σ² in the defining equation:

$$I ( x ; A , μ , {σ}^{2} ) = \frac{A}{σ \sqrt{2 π}} exp ( - \frac{{( x - μ )}^{2}}{2 {σ}^{2}} ) . \qquad Eq . 1$$

in which x is the variable of spectral dispersion (generally the independent variable or abscissa of an experiment or spectral plot) such as wavelength, frequency, or time and I is the spectral ordinate or measured or dependent variable, possibly dimensionless, such as intensity, counts, absorbance, detector current, voltage, etc. Note that a normalized Gaussian distribution (having a cumulative area of unity and only two parameters—mean and variance) would model, for instance, the probability density of the elution time of a single molecule. In the three-parameter model given in Eq. 1, the scale factor A may be taken as the number of analyte molecules contributing to a peak multiplied by a response factor.

As is known, the functional form of Eq. 1 produces a symmetric peak shape (skew, S, equal to unity) and, thus, step 511 in the method 150 (FIG. 12) utilizes a Gaussian peak shape when the estimated peak skew is in the vicinity of unity, that is when (1−ε)≦S≦(1+ε) for some positive quantity ε. In the illustration shown in FIG. 12, the quantity ε is taken as 0.05, but it could be any other pre-defined positive quantity. A statistical tit may performed within a range of data points established by a pre-defined criterion. For instance, the number of data points to be used in the fit may be calculated by starting with a pre-set number of points, such as 12 points and then adjusting, either increasing or decreasing, the total number of data points based on an initial estimated peak width. Preferably, downward adjustment of the number of points to be used in the fit does not proceed to less than a certain minimum number of points, such as, for instance, five points.

Alternatively, the fit may be mathematically anchored to the three points shown in FIG. 13. Alternatively, the range of the fit may be defined as all points of the peak occurring above the noise threshold. Still further alternatively, the range may be defined via some criterion based on the intensities of the points or their intensities relative to the maximum point 216, or even on criterion based wholly or in part on calculation time. Such choices will depend on the particular implementation of the method, the relative requirements for calculation speed versus accuracy, etc.

If S>(1+ε), then the data peak is skewed so as to have an elongated tail on the right-hand side. This type of peak may be well modeled using either a peak shape based on either the Gamma distribution function or on an exponentially modified Gaussian (EMG) distribution function. Examples of peaks that are skewed in this fashion (all of which are synthetically derived Gamma distributions are shown as graph 220 in FIG. 14. If the peaks in FIG. 14 are taken to be chromatograms, then the abscissa in each case is in the units of time, increasing towards the right.

The general form of the Gamma distribution function, as used herein, is given by:

$$( x ; A , {x}_{0} , M , r ) = A \frac{{{r}^{M} ( x - {x}_{0} )}^{M - 1} {e}^{- r ( x - {x}_{0} )}}{Γ ( M )} x \geq {x}_{0} \qquad Eq . 2$$

in which the dependent and independent variables are x and I, respectively, as previously defined, Γ(M) is the Gamma function, defined by

$$Γ ( M ) = {\int }_{0}^{∞} {u}^{M - 1} {e}^{- u} d u$$

and are A, x₀, M and r are parameters, the values of which are calculated by methods described herein. Note that references often provide this in a “normalized” form (i.e., a probability density function), in which the total area under the curve is unity and which has only three parameters. However, as noted previously herein, the peak area parameter A may be taken as corresponding to the number of analyte molecules contributing to the peak multiplied by a response factor.

It is here assumed that a chromatographic peak of a single analyte exhibiting peak tailing may be modeled by a four-parameter Gamma distribution function, wherein the parameters may be inferred to have relevance with regard to physical interaction between the analyte and the chromatographic column. In this case, the Gamma function may be written as:

$$I ( t ; A , {t}_{0} , M , r ) = A \frac{{{r}^{M} ( t - {t}_{0} )}^{M - 1} {e}^{- r ( t - {t}_{0} )}}{Γ ( M )} t \geq {t}_{0} \qquad Eq . 2 a$$

in which t is retention time (the independent variable), A is peak area, t₀ is lag time and M is the mixing number. Note that if M is a positive integer then Γ(M)=(M−1)! and the distribution function given above reduces to the Erlang distribution. The adjustable parameters in the above are A, t₀, M and r. FIG. 14 illustrates four different Gamma distribution functions for which the only difference is a change in the value of the mixing parameter, M. For curves 222, 224, 226 and 228, the parameter M is given by M=2, M=5, M=20 and M=100, respectively. In the limit of high M, the Gamma function approaches the form of a Gaussian function.

The general, four-parameter form of the exponentially modified Gaussian (EMG) distribution, as used in methods described herein, is given by a function of the form:

$$I ( x ; A , {x}_{0} , {σ}^{2} , τ ) = A {\int }_{- ∞}^{x} \frac{1}{σ \sqrt{2 π}} {e}^{- {( u - {x}_{0} )}^{2} / 2 {o}^{2}} \frac{1}{τ} {e}^{- ( x - u ) / τ} d u \\ ( x \geq 0 ; τ > 0 ) . \qquad Eq . 3$$

Thus, the EMG distribution used herein is defined as the convolution of an exponential distribution with a Gaussian distribution. In the above Eq. 3, the independent and dependent variables are x and I, as previously defined and the parameters are A, t₀, σ², and τ. The parameter A is the area under the curve and is proportional to analyte concentration and the parameters t₀ and σ² are the centroid and variance of the Gaussian function that modifies an exponential decay function. An exponentially-modified Gaussian distribution function of the form of Eq. 3 may be used to model some chromatographic peaks exhibiting peak tailing. In this situation, the general variable x is replaced by the specific variable time t and the parameter x₀ is replaced by t₀.

FIG. 15 illustrates, in greater detail, various sub-steps that may be included in the step 512 of the method 150 (see FIG. 8 and FIG. 12). More generally, FIG. 15 outlines an exemplary method for choosing between peak shape forms in the modeling and fitting of an asymmetric spectral peak. The method 512 illustrated in FIG. 15 may be entered from step 510 of the method 150 (see FIG. 12). When method 512 is entered from step 510, the skew, S, is greater than (1+ε), because the respective “No” branch has previously been executed in each of steps 509 and 510 (see FIG. 12). For instance, if ε is set to 0.05, then the skew is greater than 1.05. When S>(1+ε), both the EMG distribution (in the form of Eq. 3) and the Gamma distribution may be fit to the data and one of the two distributions may be selected as a model of better fit on the basis of the squared difference (chi-squared statistic).

From step 232, the method 512 (FIG. 15) proceeds to step 234, in these two steps, first one peak shape and then an alternative peak shape is fitted to the data and a chi-squared statistic is calculated for each. The fit is performed within a range of data points established by a pre-defined criterion. For instance, the number of data points to be used in the fit may be calculated by starting with a pre-set number of points, such as 12 points and then adjusting, either increasing or decreasing, the total number of data points based on an initial estimated peak width. Preferably, downward adjustment of the number of points to be used in the fit does not proceed to less than a certain minimum number of points, such as, for instance, five points.

Alternatively, the fit may be mathematically anchored to the three points shown in FIG. 13. Alternatively, the range may be defined as all points of the peak occurring above the noise threshold. Still further alternatively, the range may be defined via, some criterion based on the intensities of the points or their intensities relative to the maximum point 216, or even on criterion based wholly or in part on calculation time. Such choices will depend on the particular implementation of the method, the relative requirements for calculation speed versus accuracy, etc. Finally, in step 236, the fit function is chosen as that which yields the lesser chi-squared. The method 512 then outputs the results or exits to step 516 of method 150 (see FIG. 12).

### 4.3. Refinement

Returning, once again, to the method 48 as shown in FIG. 8, it is noted that, after all peaks have been fit in step 150, the next optional step, step 170 comprises refinement of the initial parameter estimates for multiple detected chromatographic peaks. Refinement comprises exploring the space of N parameters (the total number of parameters across all peaks, i.e. 4 for each Gamma/EMG and 3 for each Gaussian) to find the set of values that minimizes the sum of squared differences between the observed and model chromatogram. Preferably, the squared difference may be calculated with respect to the portion of the chromatogram comprising multiple or overlapped peaks. It may also be calculated with respect to the entire chromatogram. The model chromatogram is calculated by summing the contribution of all peaks estimated in the previous stage. The overall complexity of the refinement can be greatly reduced by partitioning the chromatogram into regions that are defined by overlaps between the detected peaks. In the simplest case, none of the peaks overlap, and the parameters for each individual peak can be estimated separately.

The refinement process continues until a halting condition is reached. The halting condition can be specified in terms of a fixed number of iterations, a computational time limit, a threshold on the magnitude of the first-derivative vector (which is ideally zero at convergence), and/or a threshold on the magnitude of the change in the magnitude of the parameter vector. Preferably, there may also be a “safety valve” limit on the number of iterations to guard against non-convergence to a solution. As is the case for other parameters and conditions of methods described herein, this halting condition is chosen during algorithm design and development and not exposed to the user, in order to preserve the automatic nature of the processing. At the end of refinement, the set of values of each peak area along with a time identifier (either the centroid or the intensity maximum) is returned. The entire process is fully automated with no user intervention required.

### Section 5. Elution Profile Correlation

### 5.1. Peak Shape Reproduction by Parameterless Peak Detection Methods

The extracted ion chromatogram (XIC) peak shapes for components that elute at similar times are not all the same, neither are they all different. FIG. 17 shows results from a typical situation, in which the peak shapes in various extracted ion chromatograms fall into several groups of patterns indicated by the peak profiles s1-s8. Comparisons between the schematically illustrated XIC peak profiles in FIG. 3A illustrate how precursor-ion profiles may be similar in shape to the profiles of product ions—e.g., fragment ions or adduct ions wherein the adducted groups arise from background compounds present in relatively constant amounts or in excess relative to analyte compounds—relating to elution of the analyte same compounds. FIG. 3A also illustrates how profiles relating to elution of different compounds may be expected to have different respective shapes. Since the chemistry and physics that determine the chromatographic peak shape are unique for each molecule and cease when the molecule exits the column, one can expect that XICs having similar shapes may be related. By using Parameterless Peak Detection (PPD) techniques, as described in Section 4 herein, to characterize the peak shape, small differences in shape can be encoded in a correlation vector (described in more detail following). This can be enhanced by additional smoothing after the peak is detected (but not before, since prior smoothing can smooth a noise spike into a peak). Step 59 of method 40 (FIG. 6A) is the cross-correlation step which is described in more detail in the following section.

### 5.2. Cross Correlation Calculations

Overall cross-correlation scores (CCS) in accordance with the methods described herein may be calculated (i.e., in step 59 of method 40) according to the following strategy. For each mass in the experimental data that is found to form a chromatographic peak by PPD as described in Section 4, the cross correlation of every mass with every other mass is computed. In the present context, the term “peak” refers simply to masses (i.e., ion types) that have non-zero intensity values for several contiguous or nearly contiguous scans (for example, the scans at times rt1, rt2, rt3 and rt4 illustrated in FIG. 3A). Each cross-correlation score may be calculated as a weighted average of a peak shape correlation score (calculated in terms of a time-versus-intensity for each mass that forms a recognized peak), in conjunction with an optional mass defect correlation score (for differences along the m/z axis) and an optional peak width correlation score as described below. If a calculated overall correlation score is such that a match between masses is recognized, then a precursor/product relationship between correlated ions may be recognized.

A trailing retention time window may be used to calculate peak-shape cross correlations. The correlation calculations may make use of a numerical array including mass, intensity, and scan number values for every mass that forms a chromatographic peak. As described in Section 4, Parameterless Peak Detection (PPD) may used to calculate a peak shape for each mass component. This shape may be a simple Gaussian or Gamma function peak, or it may be a sum of many Gaussian or Gamma function shapes, the details of which are stored in a peak parameter list. Once the component peak shape has been characterized by an analytical function (which may be a sum of simple functions), it becomes a trivial matter to calculate a cross correlation, here considered as a simple vector product (“dot product”). These cross correlations are normalized by also calculating, and dividing by, the autocorrelation values. Consequently, the peak shape correlation (NC) between two peak profiles, p1 and p2 (denoted, functionally as p1(t) and p2(i), where t represents a time variable, may be calculated as

$$PSC ( p 1 , p 2 ) = \frac{{\sum }_{j = j min}^{j = j max} [ p 1 ( {t}_{j} ) \times p 2 ( {t}_{j} ) ]}{{\{ {\sum }_{j = j min}^{j = j max} p 1 {( {t}_{j} )}^{2} \}}^{1 / 2} {\{ {\sum }_{j = j min}^{j = j max} p 2 {( {t}_{j} )}^{2} \}}^{1 / 2}} \qquad Eq . 4$$

in which the time axis is considered as divided into equal width segments, thus defining indexed time points, tⱼ, ranging from a practically defined lower time bound, t_{j min}, to a practically defined upper time bound, t_{j max}. Accordingly, the quantity PSC can theoretically have a range of 1 (perfect correlation) to −1 (perfect anti-correlation), but since negative going chromatographic peaks are not detected by PPD (by design) the lower limit is effectively zero. For example, the lower and upper time bounds, t_{j min}, and, t_{j max}, may be set in relation to each precursor ion. In such a case, the time values are chosen so as to sample intensities a fixed number of times (for instance, between roughly seven and fifteen times, such as eleven times) across the width of a precursor ion peak. The masses to be correlated with the chosen precursor ion then use the same time points. This means that if these masses form a peak at markedly different times, the intensities will be essentially zero. Partially overlapped peaks will have some zero terms.

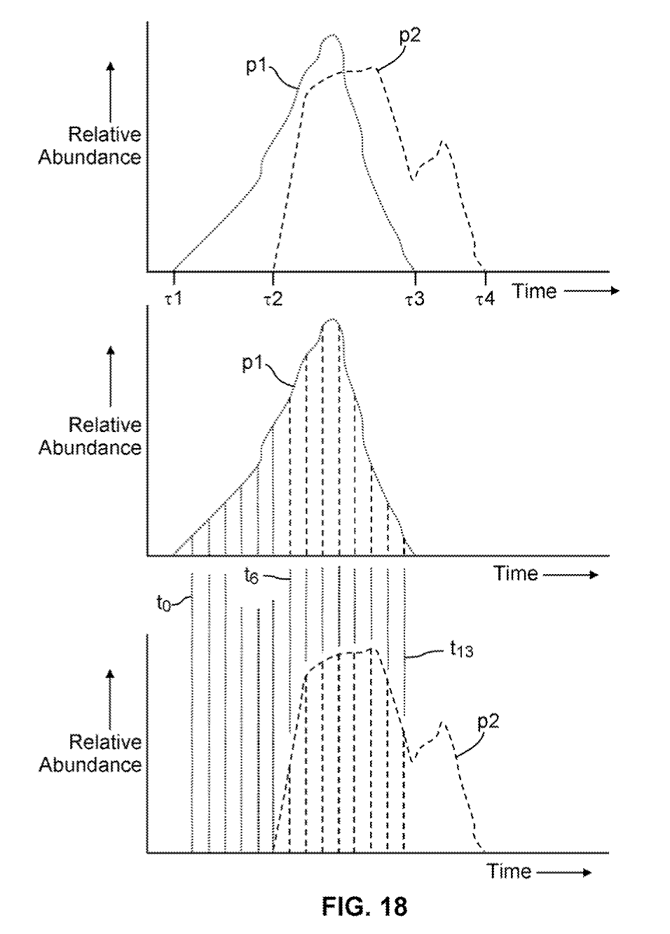

FIG. 18 graphically illustrates calculation of a dot product cross-correlation score in this fashion. In FIG. 18, two XIC peak profiles p1 and p2 are reproduced from FIG. 3. Peak p1 has appreciable intensity above baseline only between time points τ1 and τ3 and peak p2 has appreciable intensity only between time points τ2 and τ4. Assume that peak profile p1 corresponds to a precursor ion (or precursor ion candidate) and that peak p2 corresponds to a product ion (or product ion candidate). As discussed above, to calculate the dot-product cross correlation score between these two peaks, the retention time axis may be considered as being divided into several equal segments between time points τ1 and τ3, thereby defining, in this example, indexed time points tⱼ where (0≦j≦13). The two peak profiles are shown separately in the lowermost two graphs of FIG. 18 in association with vertical lines representing the various indexed time points along the retention time axis. In this representation, peak p2 only has appreciable intensity between the points t₆ and t₍₁₃₎. Thus, in this example, the peak shape correlation is given by

$$PSC ( p 1 , p 2 ) = \frac{{\sum }_{j = 0}^{j = 13} [ p 1 ( {t}_{j} ) \times p 2 ( {t}_{j} ) ]}{{\{ {\sum }_{j = 0}^{j = 13} p 1 {( {t}_{j} )}^{2} \}}^{1 / 2} {\{ {\sum }_{j = 0}^{j = 13} p 2 {( {t}_{j} )}^{2} \}}^{1 / 2}}$$

Under such a calculation, the cross-correlation score, as calculated above, for the peaks p1 and p2 illustrated in FIG. 18 would be a positive number because the peaks partially overlap, but would be below a threshold score for recognizing a peak match, since the peaks have different shapes. The cross-correlation score for a peak with itself or with a scaled version of itself is unity. Note from FIG. 3A that, by this measure, the peaks p4 and f4 would have a high cross-correlation score even though they have different magnitudes. In the same fashion, peak p2 would strongly correlate with peak 12 and peak p1 would strongly correlate with peak f1. By contrast, the cross-correlation score between the peaks p3 and p4 illustrated in FIG. 3B would be essentially zero because these peaks have no overlap (every term in the numerator of Eq. 4 would be essentially zero).

The correlation method also may also calculate and include a mass defect correlation. The mass defect is simply the difference, Δm, between the unit resolution mass and the actual mass, expressed in a relative sense such as parts per million (ppm). Thus the mass defect for a peak, p, can be expressed as:

$${MD}_{p} = 1000000 \times \frac{Δ {m}_{p}}{{m}_{p}} \qquad Eq . 5$$

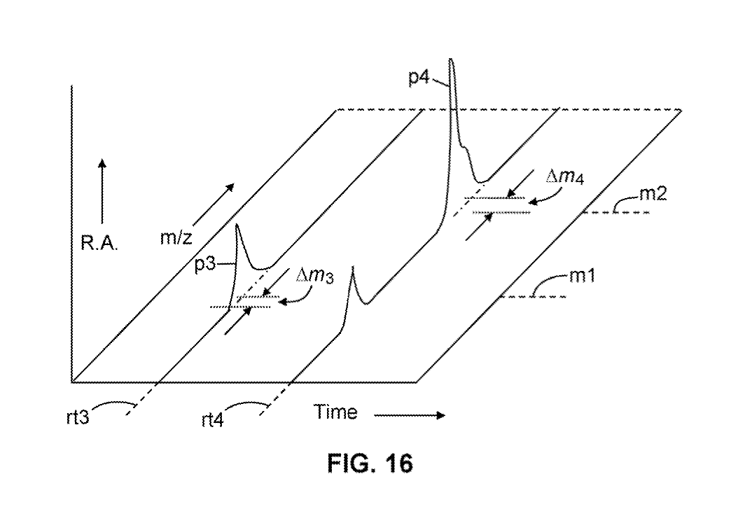

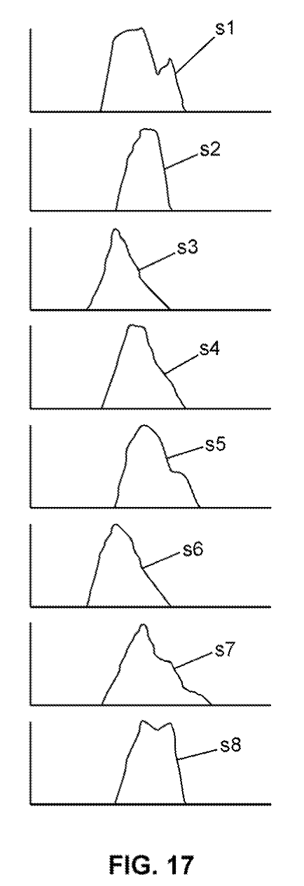

FIG. 16 illustrates how the quantities Δm₃ and Δm₄ may be determined for the peaks p3 and p4, respectively. Note that the sign of the mass defect is negative for peak p3 and positive for peak p4. The peaks p3 and p4 illustrated in FIG. 16 are the same peaks as illustrated in FIG. 3B, but are shown along the mass axis instead of the orthogonal time axis, as in FIG. 3B. Thus, the mass defect provides an independent measure of the potential relatedness of the peaks. This is true in the broadest sense if one considers the mass defect to arise from numerous small contributions from all the atoms in the structure, and the fragments to be of composition typical to the whole. So, for example, an alkane chain that is fragmented will have the same mass defect (on a relative basis) in both halves. On the other hand, chlorobenzene that is fragmented into benzene and chloride ions will have markedly different mass defects. Likewise, the mass defect correlation may not work well for the correlation of adducts with their precursors.

The mass defect correlation, MDC_{(p1,p2)}, between two peaks p1 and p2, is computed simply as

MDC_{(p1,p2)}=1−A(MDₚ₁−MDₚ₂) Eq. 6

where A is a suitable multiplicative constant. Therefore the mass defect correlation ranges from 1 (exactly the same relative defect) to some small number that depends on the value of A.

If it is desired to also use a peak width correlation, which is calculated by a similar formula, using the absolute peak widths as determined by PPD on the XIC peak shapes. Accordingly, an optional peak width correlation. PWC_{(p1,p2)}, between peaks p1 and p2 may be calculated by

PWC_{(p1,p2)}=1−B|widthₚ₁−widthₚ₂| Eq. 7

in which B is the inverse of the maximum of widthₚ₁ and widthₚ₂ and the vertical bars represent the mathematical absolute value operation.

The cross-correlation score calculation, as shown in step 59 of method 40 (FIG. 6A) may be calculated by combining the peak-shape correlation score, PSC, together with the mass defect correlation score, MDC, and possibly with the peak width correlation score, PWC, as a weighted average. Accordingly, the overall correlation score, CCS_{(p1,p2)}, is given by

CCS_{(p1,p2)}={X[PSC_{(p1,p2)}]+Y[MDC_{(p1,p2)}]+Z[PWC_{(p1,p2)}]}/{X+Y+Z} Eq. 8

in which X, Y and Z are weighting factors. Thus, the overall score, CCS, ranges from 1.0 (perfect match) down to 0.0 (no match). Peak matches are recognized when a correlation exceeds a certain pre-defined threshold value. Experimentally, it is observed that limiting recognized matches to scores to those above 0.90 provides reconstructed MS/MS spectra that match extremely well to experimental spectra.

### Section 6. Elution Profile Correlation by Recognition of Neutral Losses

FIGS. 19A-19B present a flowchart of a method 240 for generating automated correlations between all-ions precursor ions and all-ions-fragmentation product ions in accordance with the present teachings. In the initial step, step 241 (FIG. 19A), all-ions LC/MS/MS data is generated by and received from a chromatograph-mass spectrometer apparatus. Note that the LC/MS data may comprise two data subsets—one data subset containing data for precursor ions and the other data subset containing data for all the fragment ions formed by reaction or fragmentation of all the precursor ions. Each data subset comprises ion abundance (or relative abundance) information as a function of time and m/z.

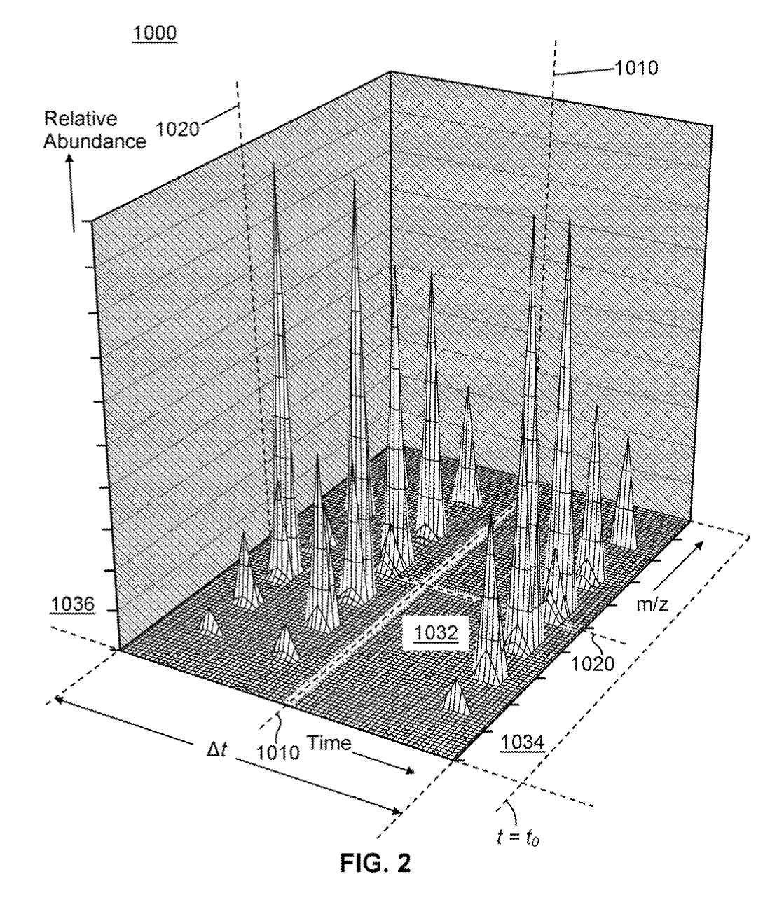

The calculations of method 240 are performed on a chosen time window of the data set. This time-window corresponds to a current region of interest (ROI) of recently collected data, such as region 1032 of FIG. 2. The region of interest includes data from the precursor ion scan (MS scan) as well as the fragment ion scan (MS/MS scan). In embodiments, this window is 0.6 minutes wide. This time windows represent a small portion of a typical chromatographic experiment which may run for several tens of minutes to on the order of an hour. In some implementations, data dependent instrument control functions may be performed in automated fashion, wherein the results obtained by the methods herein are used to automatically control operation of the instrument at a subsequent time during the same experiment from which the data were collected. For instance, based on the results of the algorithms, a voltage may be automatically adjusted in an ion source or a collision energy (that is applied to ions in order to cause fragmentation) may be adjusted with regard to collision cell operation. Such automatic instrument adjustments may be performed, for instance, so as to optimize the type or number of ions or ion fragments produced.

In step 242 of the method 240 (FIG. 19A), one or more elution events of compounds within a current region of interest (ROI) are detected. The one or more elution events may be detected as peaks within a total ion chromatogram (TIC), since a total ion chromatogram provides a useful representation of the general timing and quantity of elution of compounds from a chromatograph. The TIC may be directly measured and provided by the analytical instrument as a measure of total ion current versus time. The TIC provided by the analytical instrument may relate only to detection of precursor ions. Alternatively, a second TIC relating to product or fragment ions may also be provided by the analytical instrument. As a still further alternative, the instrument may simply provide raw data in the form of a series of mass spectra, each mass spectrum (“scan”) relating to a certain measurement time and comprising intensity data relating to the detection of possibly many different ion masses, such as, for example, precursor ion masses within a certain experimental range of masses, in such cases, the one or more total ion chromatograms may be simply calculated in step 242 by adding together the intensities of the various detected peaks in each scan.

The peaks in a total ion chromatogram may be detected by the methods of Parameterless Peak Detection as taught in U.S. Pat. No. 7,983,852 and discussed earlier in this document. In some instances, the region of interest may be defined as a time region around a single detected peak or envelope of peaks—such as, for instance, a time region bounded by limits that are at a distance of twice the standard deviation from a peak maximum on either side of the peak maximum. In some instances, the region of interest may be known or may be estimated prior to performing a particular analysis and may relate to an expected retention time of an expected or target analyte.

In the subsequent step 243, the first such identified peak is selected and subsequently considered in a loop of steps spanning from step 243 to step 266 (FIG. 1913). In steps 244 and 245, precursor-ion and fragment-ion peaks, respectively, are identified. The precursor-ion and product-ion or fragment-ion peaks may be identified by calculating extracted ion chromatograms as discussed in the aforementioned U.S. Patent Application Publication 2012/0158318 A1, each such ion chromatogram providing a representation of the quantity of ions detected within a respective mass range versus time. Each peak identified in either step 244 or step 245 represents a respective mass-to-charge range of ions whose detected intensity rises and falls in correspondence to a particular retention time.

In step 246 of the method 240, a first precursor ion peak—as identified in step 244—is selected for consideration within a loop of steps spanning from step 246 (FIG. 19A) to step 265 (FIG. 19B). In step 247, the charge state and mass of the precursor ion peak under consideration is determined. The charge state may be determined by the spacing between the various peaks of an isotopic distribution of peaks, provided that the instrumental resolution is sufficient. With the magnitude of the charge thus known, the mass of the ion may be thus determined. In step 248, a first fragment-ion peak—as identified in step 245—is selected for consideration within a loop of steps spanning, from step 248 (FIG. 19A) to step 263 (MG. 19B).

In step 249, the charge state and mass of the fragment-ion peak under consideration is determined. The charge state may be determined by the spacing between the various peaks of an isotopic distribution of peaks, provided that the instrumental resolution is sufficient. With the magnitude of the charge thus known, the mass of the ion may be thus determined. Generally, the fragment ion generated by neutral loss should comprise the same charge number as the precursor from which it was formed, the only exceptions being in special cases involving charge transfer. However, assuming collision-induced-dissociation fragmentation not including charge transfer in the dissociation mechanism, then the decision step 250 is executed. If, in step 250, the fragment ion does not comprise the same charge number, then the next identified fragment ion peak is considered (step 248) as indicated by the dashed arrow in FIG. 19A. Otherwise, if the two charge numbers are the same, then step 251 is executed.

In step 251, the mass of the fragment ion currently under consideration is subtracted from the mass of the precursor ion currently under consideration so as to provide a tentative mass difference. A list of candidate neutral loss (NL) formulas corresponding to the tentative mass difference is calculated or determined from a table of formula masses in step 252. Various databases of molecular formulas and masses are available for this purpose. Subsequently, in step 253, the first candidate neutral loss formula is considered. Note that the candidate formulas do not correspond directly to observed masses but, instead, to calculated mass differences between candidate precursor and product ions.

The candidate formula under consideration may, in some embodiments, be eliminated in step 254 if it is deemed to be unlikely or unrealistic according to various heuristic rules. A list of such rules has been set forth by Kind and Fiehn (“Metabolomic database annotations via query of elemental compositions: Mass accuracy is insufficient even at less than 1 ppm”, BMC Bioinformatics 2006, 7:234; “Seven Golden Rules for heuristic filtering of molecular formulas obtained by accurate mass spectrometry”, BMC Bioinformatics 2007, 8:105). According to Kind and Fiehn, high mass accuracy (1 ppm or better) and high resolving power are desirable but insufficient for correct molecule identification. With regard to the present teachings, mass precision is a relevant quantity since, according to the methods taught herein, lists of tentative neutral loss molecules are derived by subtracting product-ion masses from precursor-ion masses. With regard to the present teachings, therefore, mass precision of 1 ppm or better is desirable. Such mass precision is available on commercially available electrostatic trap mass spectrometer systems (e.g., Orbitrap® mass spectrometer systems) as well as on time-of-flight (TOF) and other mass spectrometer systems. However, according to Kind and Fiehn, in order to eliminate ambiguities in formula assignments, certain molecules must either be eliminated or determined to be unlikely based on certain rules.

The rules set forth by Kind and Fiehn include a restriction rule relating to the number-of-elements, the LEWIS and SENIOR chemical rules, a rule relating to hydrogen/carbon ratios, a rule relating to the element ratio of nitrogen, oxygen, phosphor, and sulphur versus carbon, a rule relating to element ratio probabilities and a rule relating to the presence of trimethylsilylated compounds. For small organic molecules, such as drugs or their metabolites, the number of elements may be restricted to just the most common elements (e.g., C, H, N, S, O, P, Br and Cl and, possibly Si for some compounds that have been derivatized) and the numbers for nitrogen, phosphor, sulphur, bromine and chlorine should be relatively small relative to carbon. Further, the hydrogen/carbon ratio should not exceed approximately H/C>3. According to the LEWIS rule, carbon, nitrogen and oxygen are expected to have an “octet” of completely filled s, p-valence shells. The SENIOR rule relates to the required sums of valences.

Some of the Kind and Fiehn rules (for example, valence rules) may be used to positively exclude certain molecules. Others of the rules may be used to calculate likelihoods or probabilities of occurrences based on tabulated observations of large collections of molecular formulas. For example, Kind and Fiehn (2007) present a histogram of hydrogen/carbon ratios for 42,000 diverse organic molecules which may be approximated by a probability density function. Probability density functions—either symmetric or skewed—may be similarly generated with regard to other element ratios. A candidate molecular formula may thus be compared against the various probability functions resulting from application of several of the heuristic rules and assigned a respective likelihood score based on each such rule. As further set forth by Kind and Fiehn, likelihood score may also be calculated in terms of the degree of matching or correlation between theoretical and observed isotopic patterns. In the present case, there is no directly observable isotopic pattern, because the candidate molecules all represent possible losses of neutral molecules. However, a pattern may be generated indirectly by conducting additional operations, in step 251, of normalizing the intensities of the observed isotopic distribution patterns of both candidate precursor and product molecules to their respective monoisotopic masses, shifting the mass axes such that monoisotopic masses overlap and then performing a simple spectral subtraction. An isotopic match score may be calculated based on a measure of correlation between the molecular isotopic pattern so calculated and an expected isotopic pattern of a candidate molecular formula.

A respective value of a formula score function is calculated in step 255, for those formulas that are not eliminated in step 254. In some embodiments, the overall formula score function may be calculated as a product of the individual likelihood scores or correlation scores calculated by application of the individual likelihood rules discussed above. The formulas which are positively excluded by certain of the rules may be eliminated from consideration in step 254, prior to this calculation. Alternatively, such excluded formulas may be presumed to comprise scores which are calculated including at least one factor which is equal to zero. In some embodiments, most of the rules may be formulated so as to yield a simple binary “yes” or “no” answer regarding the exclusion of or possible allowance of a certain formula. The final likelihood score for formulas which are not excluded in this fashion may be then calculated from the isotopic correlation scores.

Then, in the loop termination step, step 257 (FIG. 19B), if there are additional candidate neutral loss formulas to be considered, execution of the method 240 returns to step 253 and the next candidate neutral loss formula in the list is considered, in turn. Once the value of the formula score function has been calculated for all candidate neutral loss formulas, the various formulas are ranked according to their scores in step 259.

In step 261, the candidate neutral loss formula (if any) having the highest score may be associated with the precursor ion and fragment ion currently under consideration. However, if there are no candidate neutral loss formulas whose scores are at or above a pre-determined threshold, then no such formula is associated with the precursor ion and fragment ion. The assignment of a neutral loss formula to a precursor-product pair indicates that there is a significant probability that the fragment ion under consideration is related to the precursor ion under consideration by fragmentation of the precursor such that a neutral molecule having the assigned formula is released at the time of formation of the fragment ion.

In the loop termination step, step 263, if there are additional fragment-ion peaks within the ROI that have not been considered in conjunction with the precursor ion currently under consideration, then execution of the method 240 returns to step 248 (FIG. 19A) and the next identified fragment-ion peak is considered, in turn. Otherwise, execution proceeds to the next loop termination step, step 265. If, in step 265, there are additional precursor-ion peaks within the ROI that have not been considered, then execution of the method 240 returns to step 246 (FIG. 19A) and the next identified precursor-ion peak is considered, in turn. Otherwise, execution proceeds to the next loop termination step, step 266. If, in step 266, there are additional TIC peaks or elution events that have not been considered, then execution of the method 240 returns to step 243 (FIG. 19A) and the next identified elution event or peak in the TIC is considered, in turn. Otherwise, execution proceeds to the final step, step 267, of the method, in which a list of related precursor-fragment pairs, as determined by the values of the formula score function, is reported or stored. The results may be stored for later use or possibly reported to a user or in step 267.

### Section 7. Correlation by Method of Golden Pairs

The basic assumption underlying correlating precursor and product ions by the “method of golden pairs” is that an ionized precursor molecule (i.e., a precursor ion) can fragment, by two or more competing but related mechanisms, into at least two species whose non-adducted mass values simply add up to mass of the precursor molecule. The following types of species can result from the precursor molecule (however there can be more than two species):
1. a neutral (species A) and a charged fragment (species B),
2. a charged fragment (species A) and a neutral (species B), and/or
3. a charged fragment (species A) and a charged fragment (species B)—in the case where the precursor contains multiple charges.
   In each such case, the signatures of the charged fragments (charged fragment species A and charged fragment species B) may both appear in the fragmentation spectrum. As a result, a simple mathematical combination of their non-adducted mass values will lead to the non-adducted mass value of the precursor ion. Accordingly, a simple algorithm that searches for sets of ions such that, for example, m₁+m₂+m₃ (see FIG. 20) where m₁, m₂ and m₃ are the mono-isotopic masses of the non-adducted ions.

FIG. 20 is a flowchart of a method 340 for identifying sets of ions by the method of golden pairs. It is assumed, in this discussion, that mass peaks (m/z values) have already been determined in the current region of interest by mass analysis by a mass spectrometer. The charge state and, and the mono-isotopic mass of the ions (all precursor and product ions) are determined in steps 343-345. This information may be determined, in routine fashion, by identifying isotopic distribution envelopes and charge-state envelopes among the various mass spectral peaks. Then, in an iterated loop encompassing steps 347-354, each as-yet unassigned candidate precursor ion having, the charge state (having mass m1) is considered. For each such precursor ion, each as-yet unassigned candidate product ion having mass m2 (where m2<m1) is considered within an iterated loop encompassing steps 348-353. Then, for each group of two precursor/product, ions being examined, another product ion having mass m3 (where m3<m2) is considered within another nested iterated loop encompassing steps 349-352. In step 350, for each group of three ions being considered (precursor ion of mass m1 and product ions of masses m2 and m3), a test is made to determine if it is true that, within instrumental precision, m1=m2+m3. If so, then the ion with mass m1 is assigned as a precursor ion to both of the product ions having masses m2 and m3. Finally, after all such groups of three ions have been considered, the results are stored and perhaps reported in step 356.

### CONCLUSION

The end result of methods described in the preceding text and associated figures is a general method to detect peaks and recognize matches between ions generated in all-ions fragmentation experiments. Since these methods require no user input, they are suitable for automation, use in high-throughput screening environments or for use by untrained operators.

Although the described methods are somewhat computationally intensive, they are nonetheless able to process data faster than it is acquired, and so can be done in real time, so as to make automated real-time decisions about the course of subsequent mass spectral scans on a single sample or during a single chromatographic separation. Such real-time (or near-real-time) decision making processes require data buffering since chromatographic peaks are searched for in a moving window of time. The methods as disclosed herein may provide a listing of components found, details presented including but not limited to, chromatographic retention time and peak width, ion mass, and signal to noise characteristics.

The discussion included in this application is intended to serve as a basic description. Although the invention has been described in accordance with the various embodiments shown and described, one of ordinary skill in the art will readily recognize that there could be variations to the embodiments and those variations would be within the spirit and scope of the present invention. The reader should be aware that the specific discussion may not explicitly describe all embodiments possible; many alternatives are implicit. Accordingly, many modifications may be made by one of ordinary skill in the art without departing from the scope and essence of the invention. Neither the description nor the terminology is intended to limit the scope of the invention. Any patents, patent applications, patent application publications or other literature mentioned herein are hereby incorporated by reference herein in their respective entirety as if fully set forth herein.

What is claimed is:

1. A method for acquiring and interpreting tandem mass spectra of a plurality of compounds that are introduced into a mass spectrometer from a chromatograph, said method comprising:
(a) repeatedly performing, during a time period, the steps of:
(a1) ionizing the plurality of compounds as they elute from the chromatograph so as to generate a plurality of precursor ion species therefrom using an ion source of the mass spectrometer;
(a2) introducing the plurality of precursor ions into a fragmentation cell of the mass spectrometer operated at constant fragmentation energy so as to generate a plurality of product-ion species from all or a portion of each of the plurality of precursor ion species; and
(a3) generating a mass spectrum of the plurality of product-ion species; and
(b) recognizing matches between certain of the product ion species generated during the time period based on correlations between elution profiles of the product ion species determined from the plurality of generated mass spectra.

2. A method as recited in claim 1, further comprising identifying at least one of the compounds from a set of matched product ion species.

3. A method as recited in claim 1, further comprising:
(c) recognizing a mass spectral peak of a residual unfragmented precursor ion species from the plurality of generated mass spectra.

4. A method as recited in claim 3, further comprising:
(d) determining an elution profile of the residual unfragmented precursor ion species from the plurality of generated mass spectra; and
(e) recognizing a match between the residual unfragmented precursor ion species and at least one product ion species based on at least one correlation between the elution profile of the residual unfragmented precursor ion species and an elution profile of the at least one product ion species.

5. A method as recited in claim 3, further comprising:
(d) determining a mass of the residual unfragmented precursor ion species; and
(e) recognizing a match between the residual unfragmented precursor ion species and a product ion species based on a correspondence of a mass difference between the residual unfragmented precursor ion species and the product ion species to a loss of a valid neutral molecule.

6. A method as recited in claim 3, further comprising:
(d) determining a mass of the residual unfragmented precursor ion species; and
(e) recognizing a match between the residual unfragmented precursor ion species and a set of product ion species whose non-adducted masses sum to the non-adducted mass of the individual precursor ion species.

7. A method as recited in claim 1, further comprising:
(c) receiving, from a user, a mass of a target precursor ion species; and
(d) recognizing a match between the target precursor ion species and a product ion species based on a correspondence of a mass difference between the target precursor ion species and the product ion species to a loss of a valid neutral molecule.

8. A method as recited in claim 1, further comprising:
(c) receiving, from a user, a mass of a target precursor ion species; and
(d) recognizing a match between the target precursor ion species and a set of product ion species whose non-adducted masses sum to the non-adducted mass of the individual precursor ion species.

9. A method for acquiring and interpreting tandem mass spectra of a plurality of compounds that are introduced into a mass spectrometer from a chromatograph, said method comprising:
(a) repeatedly performing a total of m times, during a first time period, the steps of:
(a1) ionizing the plurality of compounds as they elute from the chromatograph so as to generate a plurality of precursor ion species therefrom using an ion source of the mass spectrometer;
(a2) introducing the plurality of precursor ions into a fragmentation or reaction cell of the mass spectrometer so as to generate a plurality of product-ion species from all or a portion of each of the plurality of precursor ion species; and
(a3) generating a mass spectrum of the plurality of product-ion species;
(b) generating, during the first time period, a total number n of mass spectra of the plurality of precursor ion species prior to their introduction into the fragmentation or reaction cell, wherein n<m; and
(c) recognizing matches between certain of the precursor ion species and certain of the product ion species generated during the first time period based on either correlations between elution profiles of the ion species determined from the plurality of generated mass spectra or correspondences of mass differences between ion species to losses of valid neutral molecules.

10. A method as recited in claim 9, wherein the number n is automatically set so as to be equal to the total number of peaks observed in the elution profiles of the ion species during the first time period.

11. A method as recited in claim 9, wherein the recognized matches are limited to matches between product ions and precursor ions within a list of precursor ions or a list of product ions provided by a user.

12. A method as recited in claim 9, wherein the generation of the mass spectra of the precursor ion species is periodically interleaved with the generation of the mass spectra of the product ion species, during the first time period.

13. A method as recited in claim 9, wherein the recognizing of matches between certain of the precursor ion species and certain of the product ion species further comprises recognizing at least one match between an individual precursor ion species and a set of product ion species whose non-adducted masses sum to the non-adducted mass of the individual precursor ion species.

14. A method as recited in claim 9, wherein the recognizing of matches between certain of the precursor ion species and certain of the product ion species is based on correlations between elution profiles of the ion species if the chromatographic resolution is greater than or equal to a threshold value and is otherwise based on correspondences of mass differences between ion species to losses of valid neutral molecules.

15. A method as recited in claim 9, further comprising:
(d) repeating steps (a) and (b) during a second time period, wherein a ratio n/m relating to the second time period is different from the ratio n/m relating to the first time period; and
(e) recognizing matches between certain of the precursor ion species and certain of the product ion species generated during the second time period.

16. A method as recited in claim 15, wherein the quantities m and n or the ratio n/m is automatically determined for each of the time periods.

17. A method as recited in claim 15, wherein the recognizing of matches between certain of the precursor ion species and certain of the product ion species generated during the second time period is based on correlations between elution profiles of the ion species or correspondences of mass differences between ion species to losses of valid neutral molecules.

18. A method for acquiring and interpreting tandem mass spectra of a plurality of compounds that are introduced into a mass spectrometer from a chromatograph, said method comprising:
(a) repeatedly performing, during a time period, the steps of:
(a1) ionizing the plurality of compounds as they elute from the chromatograph so as to generate a plurality of precursor ion species therefrom using an ion source of the mass spectrometer;
(a2) introducing the plurality of precursor ions into a fragmentation or reaction cell of the mass spectrometer so as to generate a plurality of product-ion species from a portion of each of the plurality of precursor ion species; and
(a3) introducing the plurality of product-ion species and a residual portion of the precursor ion species into a mass analyzer of the mass spectrometer so as to generate a mass spectrum thereof;
(b) recognizing matches between precursor ion species and product ion species generated during the time period based on either correlations between elution profiles of the ion species determined from the plurality of generated mass spectra or observed correspondences of mass differences between ion species to losses of valid neutral molecules.

19. A method as recited in claim 18, wherein the recognized matches are limited to matches between product ions and precursor ions within a list of precursor ions provided by a user.

20. A method as recited in claim 18, wherein the recognizing of matches between precursor ion species and product ion species further comprises recognizing matches between individual precursor ion species and sets of product ion species whose non-adducted masses sum to the non-adducted mass of the respective individual precursor ion species.

21. A method as recited in claim 18, wherein the recognizing of matches between precursor ion species and product ion species is based on correlations between elution profiles of the ion species if the chromatographic resolution is greater than or equal to a threshold value and otherwise is based on correspondences of mass differences between ion species to losses of valid neutral molecules.

22. A method as recited in claim 4, further comprising identifying at least one of the compounds from a recognized match between a precursor ion species and a product ion species.

23.-28. (canceled)
